(19) United States
(12) Patent Application Publication
(10) Pub. No.: US 2026/0368946 A1
(43) Pub. Date: Nov. 19, 2026

(54) CUSTOMIZATION OF DIFFUSION MODELS FOR ATTRIBUTION

(71) Applicant: ADOBE INC., SAN JOSE, CA (US)

(72) Inventors: Vishal Asnani, East Lansing, MI (US); Shruti Agarwal, San Jose, CA (US); John Philip Collomosse, Pyrford (GB)

(21) Appl. No.: 19/211,553

(22) Filed: May 19, 2025

(51) Int. Cl. G06T 11/00; G06F 40/40

(52) U.S. Cl. CPC G06T 11/00; G06F 40/40

(57) ABSTRACT

A method, apparatus, non-transitory computer readable medium, and system for generating a synthetic image includes obtaining an input prompt and a target information, wherein the input prompt indicates an image concept. A concept encoder network generates a concept token based on the input prompt and the target information, wherein the concept token represents the image concept and the target information. Subsequently, an image generation model generates a synthetic image based on the concept token, wherein the synthetic image depicts the image concept and includes an encoding of the target information.

### BACKGROUND

The following relates generally to machine learning, and more specifically to image generation using a machine learning model. Machine learning algorithms build a model based on sample data, known as training data, to make a prediction or a decision in response to an input without being explicitly programmed to do so. One area of application for machine learning is image generation.

For example, a machine learning model can be trained to predict features for an image in response to an input prompt, and then generate the image based on the predicted features. In some cases, the prompt can be used to perform complex image manipulation and compositing. Such image generation provides for a user to edit an image and generate an image with desired features and therefore makes image generation easier for a layperson.

### SUMMARY

The present disclosure describes systems and methods for image generation. Embodiments of the present disclosure include an image processing apparatus that performs customization of a machine learning model for attribution of an image concept during generation of a synthetic image. In some cases, the image concept refers to information or a style associated with an artist. For example, the generated synthetic image comprises an artist specific watermark for attribution of the synthetic image to the artist. In some examples, the machine learning model includes a customized latent diffusion model that can watermark the image concept for text-to-image generation.

An embodiment of the present disclosure includes a scalable latent diffusion model that provides concept attribution in the synthetic image. In some cases, the latent diffusion model of the present disclosure is able to attribute concepts sequentially by fine-tuning for new concepts, without retraining the entire latent diffusion model. By performing a sequential fine-tuning process, embodiments of the present disclosure are able to provide for flexibility in selecting seen and unseen concepts for attribution.

A method, apparatus, and non-transitory computer readable medium for image processing are described. One or more aspects of the method, apparatus, and non-transitory computer readable medium include obtaining an input prompt and a target information, wherein the input prompt indicates an image concept; generating, using a concept encoder network, a concept token based on the input prompt and the target information, wherein the concept token represents the image concept and the target information; and generating, using an image generation model, a synthetic image based on the concept token, wherein the synthetic image depicts the image concept and includes an encoding of the target information.

A method, apparatus, and non-transitory computer readable medium for image processing are described. One or more aspects of the method, apparatus, and non-transitory computer readable medium include obtaining an input prompt and a target information, wherein the input prompt indicates an image concept; generating, using a secret mapper network, a noise map based on the target information; and generating, using an image generation model, a synthetic image based on the input prompt and the noise map, wherein the synthetic image depicts the image concept and includes an encoding of the target information.

An apparatus and system for image processing are described. One or more aspects of the apparatus and system include a memory component; a processing device coupled to the memory component, the processing device configured to perform operations comprising: obtaining an input prompt and a target information, wherein the input prompt indicates an image concept; generating, using a concept encoder network, a concept token based on the input prompt and the target information, wherein the concept token represents the image concept and the target information; and generating, using an image generation model, a synthetic image based on the concept token, wherein the synthetic image depicts the image concept and includes an encoding of the target information.

### BRIEF DESCRIPTION OF THE DRAWINGS

FIG. 1 shows an example of an image processing system according to aspects of the present disclosure.

FIG. 2 shows an example of a method for image generation according to aspects of the present disclosure.

FIG. 3 shows an example of an image generation process according to aspects of the present disclosure.

FIG. 4 shows an example of an image generation process with attribution to artist according to aspects of the present disclosure.

FIG. 5 shows an example of a transformer network according to aspects of the present disclosure.

FIG. 6 shows an example of a latent diffusion process according to aspects of the present disclosure.

FIG. 7 shows an example of a diffusion transformer network according to aspects of the present disclosure.

FIG. 8 shows an example of a U-Net architecture according to aspects of the present disclosure.

FIG. 9 shows an example of a denoising diffusion process according to aspects of the present disclosure.

FIG. 10 shows an example of a method for image processing according to aspects of the present disclosure.

FIG. 11 shows an example of a method for image processing according to aspects of the present disclosure.

FIG. 12 shows an example of a method for training the image generation model according to aspects of the present disclosure.

FIG. 13 shows an example of a method of training a machine learning (ML) model according to aspects of the present disclosure.

FIG. 14 shows an example of a method of training a diffusion model according to aspects of the present disclosure.

FIG. 15 shows an example of a computing device according to aspects of the present disclosure.

FIG. 16 shows an example of an image processing apparatus according to aspects of the present disclosure.

FIG. 17 shows an example of a machine learning model according to aspects of the present disclosure.

### DETAILED DESCRIPTION

Existing image generation systems perform image generation based on an input text prompt. Such systems often generate images derived using an artist's work without providing appropriate recognition or compensation for the artist. Generation of such images leads to significant ethical concern among artists regarding the unauthorized use of their work. As a result, there is a growing gap between such image generation systems and the artists that leads to disconnection and disenfranchisement within the artist community.

In some cases, an existing image generation system establishes a direct causal relationship between the generated image and the training data based on proactive watermarking of the training data. However, such a system can require significant modification to the training data which is resource extensive. Moreover, in some cases, an existing image generation system performs watermarking for prevention of unauthorized use for a media item. However, such systems merely rely on the visual similarities between generated images and training images and do not influence the training data of the model. As a result, such systems are not scalable and cause inefficiencies when a new artist is added for attribution.

By contrast, embodiments of the present disclosure include an efficient and scalable image processing apparatus that can customize a latent diffusion model to watermark multiple image concepts. In some cases, the image processing apparatus is able to attribute multiple image concepts sequentially by fine-tuning for new artists or image concepts. Accordingly, by performing fine-tuning for new image concepts, embodiments of the present disclosure are able to perform selective watermarking of new image concepts without retraining the complete latent diffusion model.

Embodiments of the present disclosure include an image processing apparatus that can customize a latent diffusion model to watermark a large number of image concepts. In some cases, the image processing apparatus comprises a concept encoder network that maps a bit-secret to a token-embedding perturbation. Additionally, the image processing apparatus comprises a secret mapper network that perturbs a noise (e.g., Gaussian noise) input to the latent diffusion model based on the bit-secret.

According to an embodiment, an attention layer of the latent diffusion model is fine-tuned using a style loss. In some cases, the fine-tuned latent diffusion model generates a watermarked image that closely aligns with the input prompt (i.e., text prompt). For example, the fine-tuned latent diffusion model embeds the attribution information, based on which the fine-tuned latent diffusion model generates the watermarked image.

Embodiments of the present disclosure include an image processing apparatus configured to generate an image that represents a style of an artist provided by an input prompt and incorporates an attribution to the artist. In some cases, the image processing apparatus performs an attribution in a text-to-image latent diffusion network. In some cases, the latent diffusion network includes direct association between the generated synthetic image and the corresponding image concept via an input text prompt. For example, the text prompt is “a painting in the style of V*” or “an image of V*”, where V* refers to an artist or an image concept. In some cases, the prompt inherently creates a direct link between the generated synthetic image and the corresponding image concept.

Additionally, in some examples, when the artist or the owner of the image concept requests attribution, embodiments of the present disclosure are able to provide concept-specific watermark in the generated synthetic image. In some cases, embodiments are able to attribute directly to the image concept (i.e., instead of attributing to a subset of training images). Since the watermark is embedded in the synthetic image and is resilient to non-editorial modifications, embodiments are able to ensure that the synthetic image is consistently attributable to the conceptual source.

Embodiments of the present disclosure are configured to perform image concept attribution during an image generation process. In some cases, the efficient and flexible image processing apparatus of the present disclosure enables attribution of the image concept in a pre-trained text-to-image latent diffusion model. For example, the image processing apparatus provides for a customization-based method to embed a concept-specific watermark in the generated synthetic image. By embedding the concept-specific watermark, embodiments of the present disclosure are able to provide for an artist to request attribution for the artist's work.

Embodiments of the present disclosure are configured to perform selective attribution for the image concepts. In some cases, the image processing apparatus provides for the selective attribution without using each concept to be predefined before training. In some cases, the image processing apparatus performs watermarking of the complete training set. In some cases, the image processing apparatus supports sequential learning to incorporate a new concept in an online method.

According to an embodiment of the present disclosure, the image processing apparatus includes an image generation model that generates a synthetic image. Additionally, the image processing apparatus includes a concept encoder network, a secret mapper network, and a decoder network. In some examples, the concept encoder network includes a U-Net based network that processes and transforms sequential data (e.g., 1-D sequential data). For example, a fully connected layer maps a bit sequence to a feature vector and performs concatenation with a token embedding associated with the image concept. In some cases, the concatenation is provided as input to the U-Net (e.g., encoder-decoder architecture of the U-Net) to generate a perturbed token embedding.

In some examples, the secret mapper network comprises a feature transformation module. For example, the secret mapper network is designed to encode an input index into a high-dimensional representations using an embedding-based method. In some cases, the secret mapper network employs a learnable embedding layer that maps input indices (e.g., 16 indices) to a vector in a high-dimensional space (e.g., 64). In some cases, the embeddings are initialized and scaled to maintain a unit standard deviation.

In some examples, the decoder network is initialized with an arbitrary weight or a pre-trained weight for feature extraction. In some cases, a last classifier layer of the decoder network is replaced with a fully connected layer. For example, the replaced fully connected layer outputs the predicted bit sequence (i.e., the predicted target information).

As used herein, the input prompt refers to a natural language description that defines the overall context in the image to be generated. In some cases, the input prompt includes a natural language description that defines a scene to be generated. For example, the input prompt describes the scene with a concept.

As used herein, the target information refers to a concept specific bit-sequence of a pre-defined length (i.e., a bit secret). In some examples, the bit sequence refers to a sequence of 12 bits. In some examples, the bit sequence refers to a sequence of 16 bits. For example, the bit sequence comprises values of 0 and/or 1. In some examples, a bit secret of a clean image refers to a zero-sequence. In some examples, a bit sequence of a watermarked image refers to a sequence of zeros and ones.

As used herein, the concept or an image concept refers to a semantic entity, attribute, or compositional feature that is visually represented or inferable from one or more regions within the image. In some cases, an image concept includes object categories, scene types, abstract ideas, etc. encoded in the image content. For example, the image concept may include, but is not limited to, a visual idea, such as an artist style (e.g., VanGogh style of paining), a daytime or a nighttime scene, etc.

In some cases, an image concept is represented as a concept token. A system includes an encoder (such as the concept encoder network) that maps the visual input or image concept to a latent space. For example, the concept token refers to a vector embedding in the latent space. In some examples, the concept token is derived based on training on paired visual and textual data.

As used herein, an encoding of a target information refers to a process by which the target information including the sequence of bits (e.g., sequence of binary digits) is transformed into a structured representation. In some cases, the encoding may include a discrete code or a continuous vector embedding while preserving characteristics of the original sequence. The encoded representation may be utilized in generative and predictive tasks including, but not limited to, synthetic image generation and decoding the synthetic image to predict the target information.

As used herein, the synthetic image or image refers to a synthetized image where the element (or a plurality of elements) are placed according to the spatial constraint and the depth constraint provided as input. Additionally, the synthetic image or image refers to the synthetized image where the element (or the plurality of elements) in an image accurately align with the input prompt while ensuring a coherent visual composition.

As described herein, a perturbation introduces divergence of the norm and provides for controlled variability to the token space which contributes to the distinctiveness of the token. In some cases, the perturbation maintains a minimum overlap of the perturbed token with the original token direction. By maintaining the minimum overlap between the perturbed token and the original token, embodiments are able to ensure effective attribution in the synthetic image.

Accordingly, by fine-tuning the latent diffusion model for a new image concept with minimum computational resources, embodiments of the present disclosure are able to streamline the concept attribution process which results in a scalable and ethical synthetic (i.e., watermarked) image generation. Additionally, by performing the sequential learning that includes a new image concept online, embodiments are able to generate diverse images associated with a plurality of artists while maintaining the quality of the synthetic image and providing image attribution.

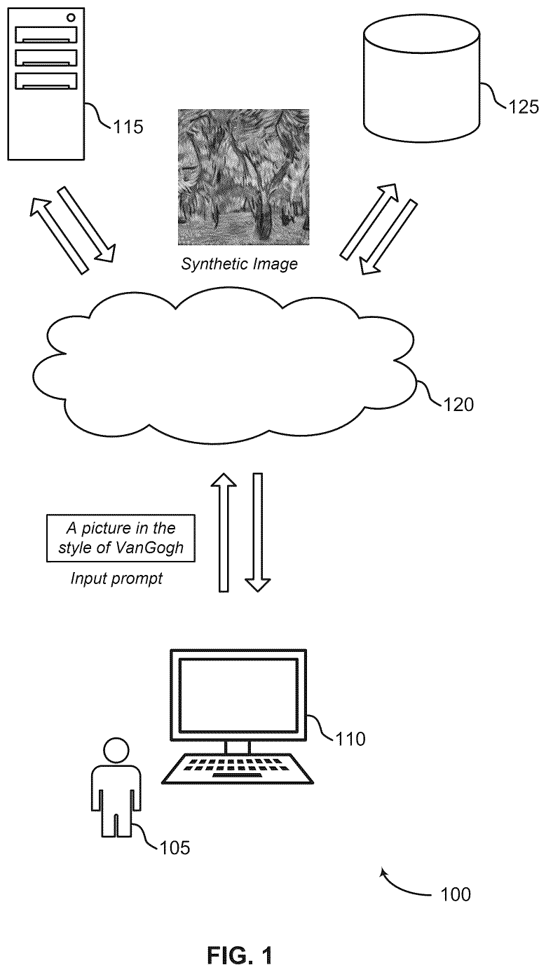

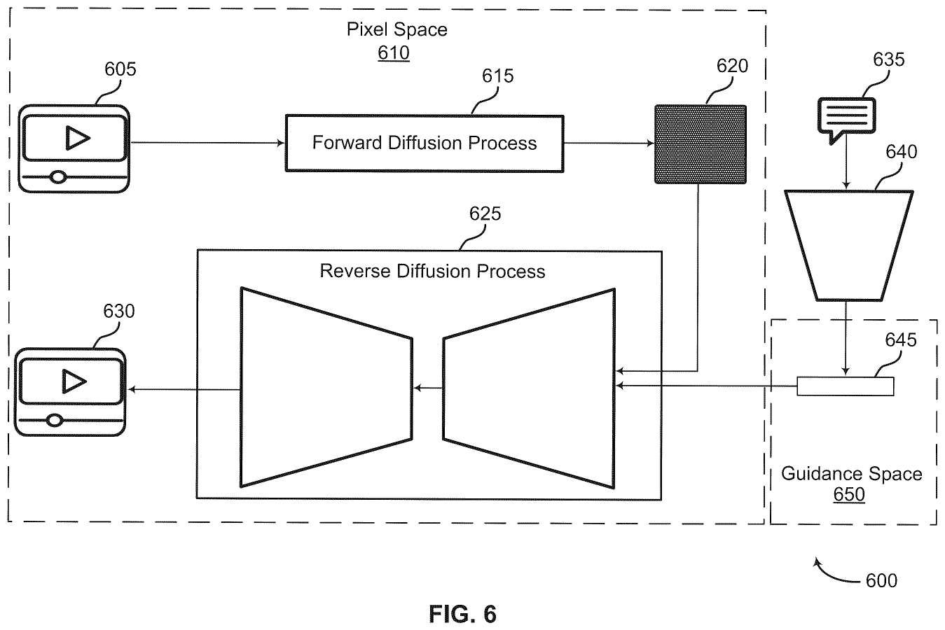

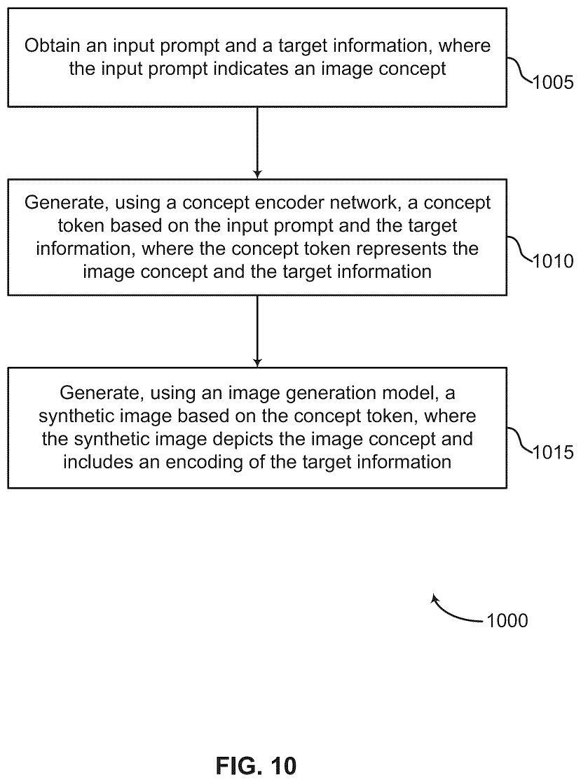

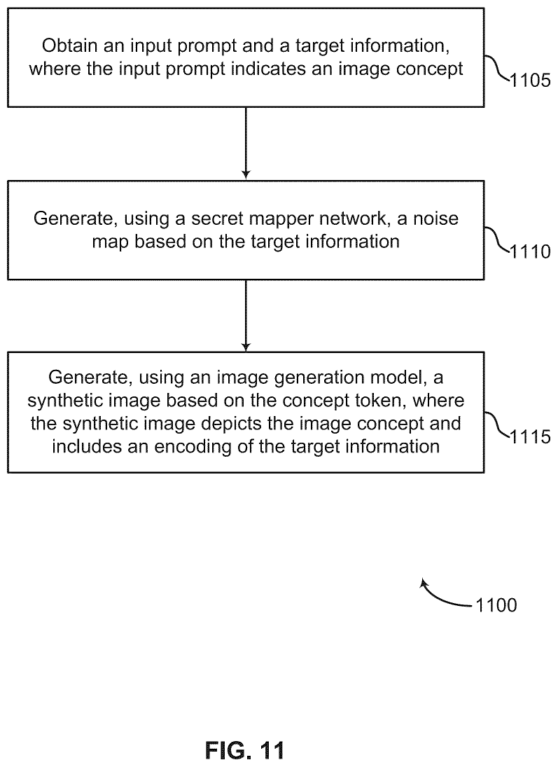

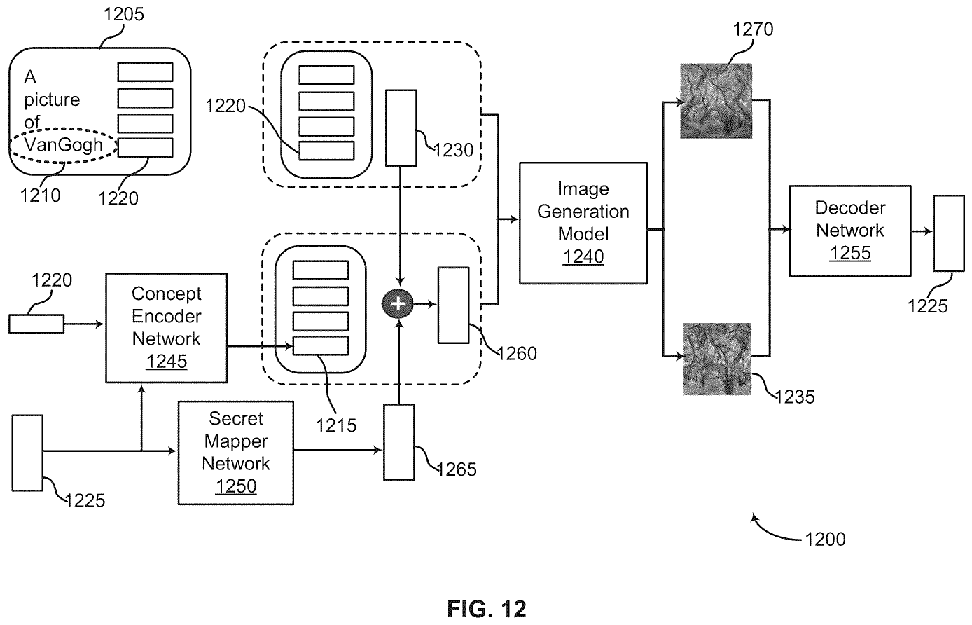

Embodiments of the present disclosure can be implemented in an image processing system. For example, the image processing system of the present disclosure takes an input prompt (e.g., providing an artist name) and generates an image that accurately attributes a style of the artist provided by the input prompt. Example applications regarding generating an image are provided with reference to FIGS. 1-4. Details regarding the architecture of the image processing apparatus are provided with reference to FIGS. 6-9 and 15-17. Details regarding an operation of the image processing apparatus are provided with reference to FIGS. 10-11. Examples of a process for training the image processing apparatus are provided with reference to FIGS. 12-14.

### Image Attribution System

A system and an apparatus for image processing are described with reference to FIGS. 1-10. FIG. 1 shows an example of an image processing system 100 according to aspects of the present disclosure. In one aspect, image processing system 100 includes user 105, user device 110, image processing apparatus 115, cloud 120, and database 125.

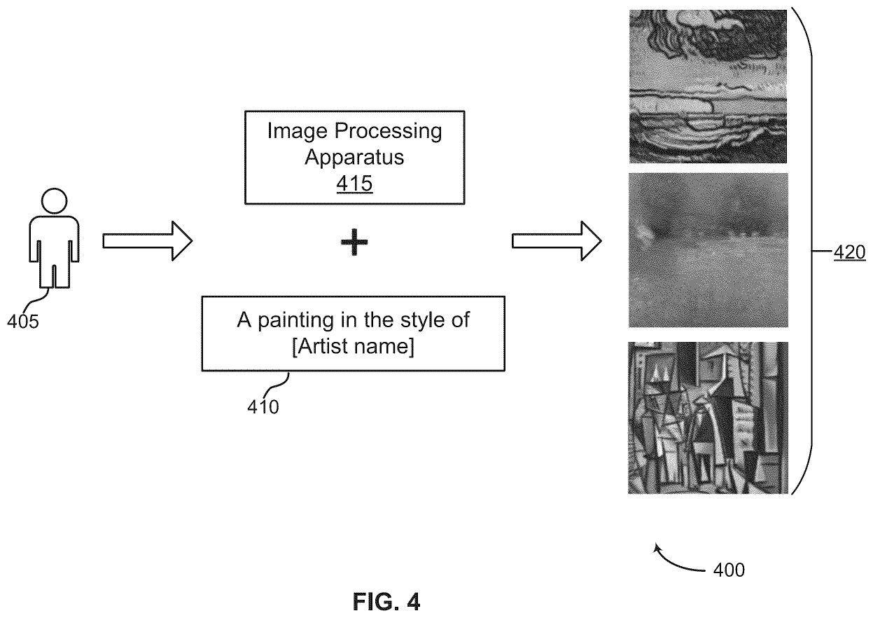

In the example of FIG. 1, user 105 provides a prompt indicating a style of an artist to image processing apparatus 115 via a user interface provided on user device 110 by image processing apparatus 115. In some examples, the input prompt refers to a text-based (i.e., a natural language based) prompt. As shown in FIG. 1, the input prompt describes an element or a scene based on which user 105 wants to generate an image using the image processing apparatus 115 of the present disclosure. User 105 is an example of, or includes aspects of, the corresponding element described with reference to FIG. 4.

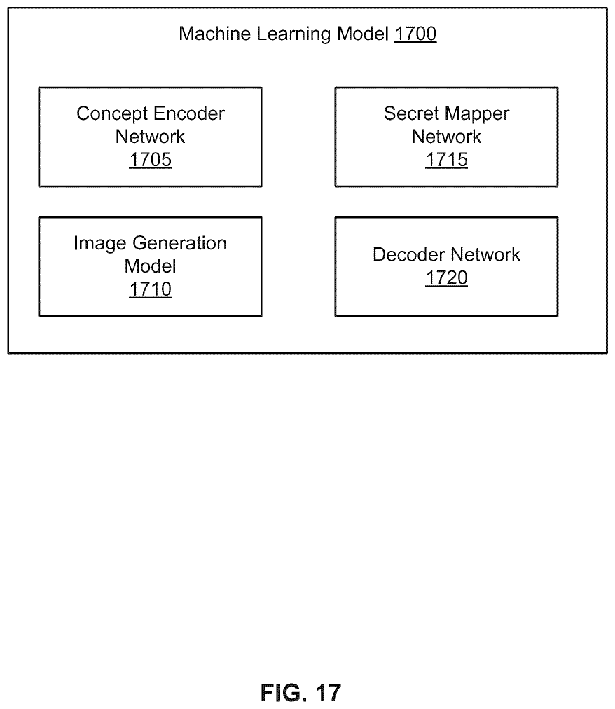

In some cases, the image processing apparatus 115 implements a concept encoder network (such as the concept encoder network 1705 described with reference to FIG. 17), a secret mapper network (such as the secret mapper network 1715 described with reference to FIG. 17), an image generation model (such as the image generation model 1710 described with reference to FIG. 17), and a decoder network (such as the decoder network 1720 described with reference to FIG. 17) to generate a synthetic image that depicts the scene described by the input prompt in the artistic style provided in the input prompt and decode the synthetic image to predict a target information (e.g., a bit secret) associated with the synthetic image.

For example, as shown in FIG. 1, the user provides an input prompt (e.g., “A picture in the style of VanGogh”) to the image processing apparatus 115, for which the user wants to generate an image. In some examples, the image processing apparatus 115 generates an image that accurately depicts a scene in the style of artist, VanGogh, provided by the input prompt. Additionally, the decoder network predicts the bit secret based on a comparison between the synthetic image and a clean image.

In some cases, the bit secret refers to a concept specific bit-secret of a pre-defined length. In some examples, the bit secret refers to a sequence of 12 bits. For example, the bit secret comprises values of 0 and/or 1. In some examples, a bit secret of a clean image refers to a zero-sequence (e.g., bit secret of a clean image is 000000000000). In some examples, a bit secret of synthetic image (such as a watermarked image) refers to a combined sequence of zeros and ones (e.g., bit secret of a watermarked image is 110010101111). However, embodiments are not limited thereto, and in some examples, the bit sequence refers to a sequence of 16 bits.

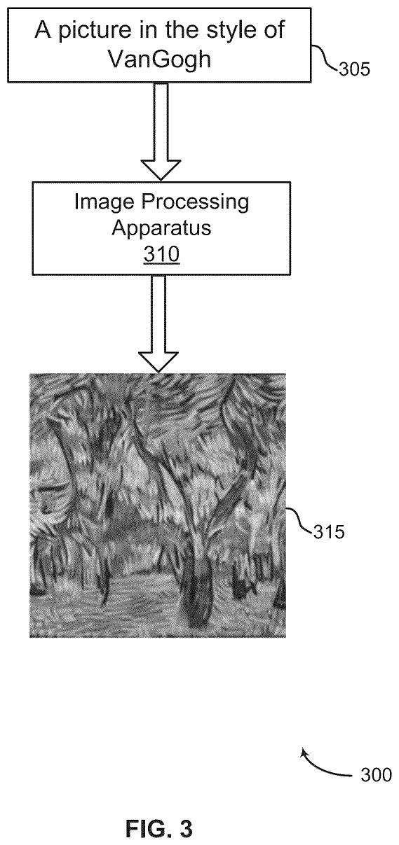

Image processing apparatus 115 provides for generation of a high-quality synthetic image with a desired artistic style. In some cases, the image processing apparatus 115 takes an input prompt, captures a name of the artist in the input prompt, and generates a synthetic image that depicts each aspect of the input prompt while incorporating the artistic style of the captured artist. Image processing apparatus 115 is an example of, or includes aspects of, the corresponding element described with reference to FIGS. 3-5.

As shown in FIG. 1, the image processing apparatus 115 generates the synthetic image that accurately depicts artistic style described in the input prompt. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image processing apparatus 115. In some aspects, the user interface provides for information (such as text, images (an input image or an input query), video, a prompt, a canvas, etc.) to be communicated between user 105 and image processing apparatus 115.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

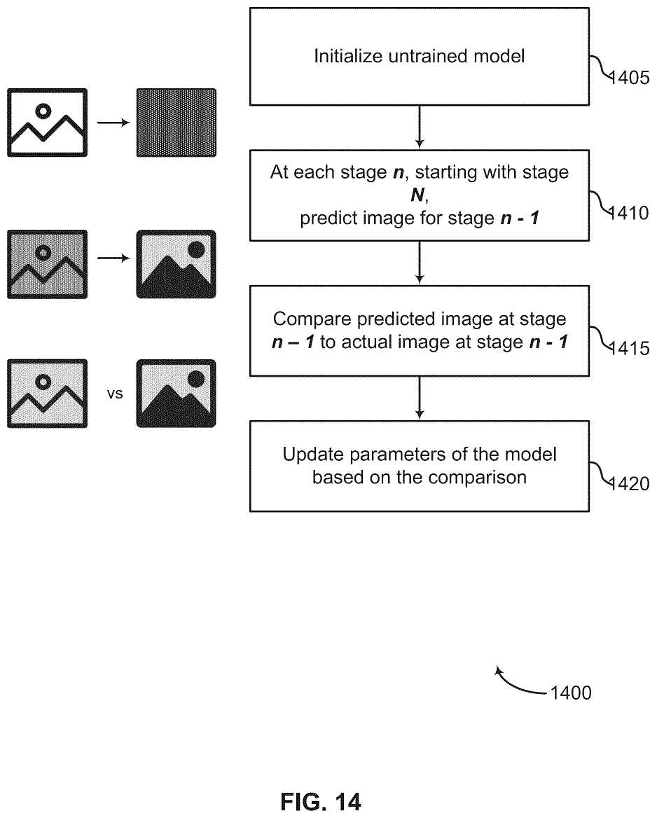

According to some aspects, image processing apparatus 115 includes a computer-implemented network. In some embodiments, the computer-implemented network includes an image generation model (such as the image generation model described with reference to at least FIGS. 6-9). In some embodiments, image processing apparatus 115 also includes one or more processors, a memory subsystem, a communication interface, an I/O interface, one or more user interface components, and a bus as described with reference to FIG. 14. Additionally, in some embodiments, image processing apparatus 115 communicates with user device 110 and database 125 via cloud 120.

In some cases, image processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, image processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image processing apparatus 115 and communicates with image processing apparatus 115 via cloud 120. According to some aspects, database 125 is included in image processing apparatus 115.

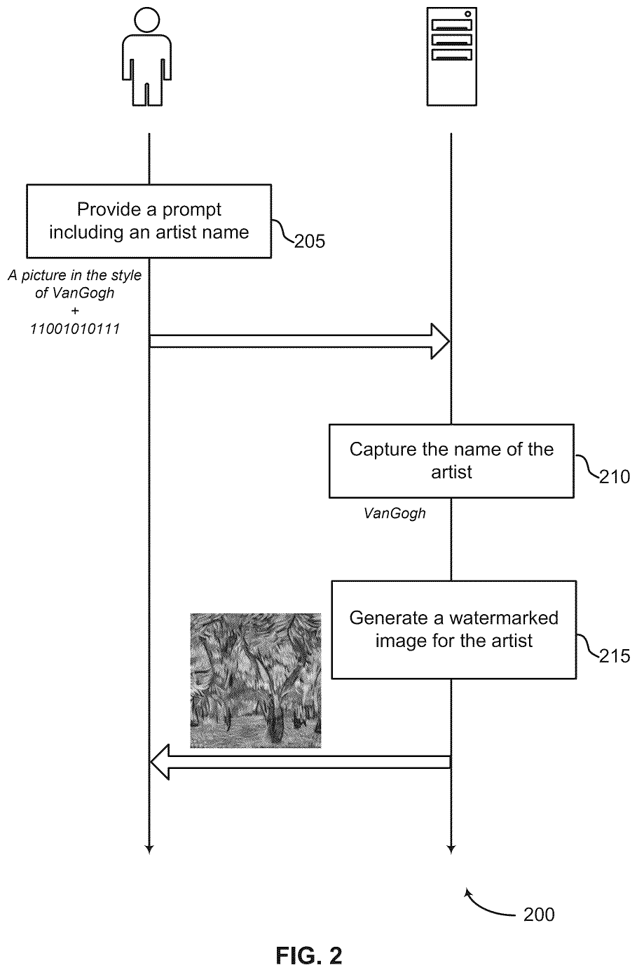

FIG. 2 shows an example of a method 200 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

According to an embodiment of the present disclosure, an image processing apparatus (such as the image processing apparatus described with reference to FIGS. 1-4 and 15-17) provides a concept encoder network (such as the concept encoder network described with reference to FIG. 17), a sequence mapper network (such as the sequence mapper network described with reference to FIG. 17), an image generation model (such as the image generation model described with reference to FIGS. 6-9 and 17), and a decoder network (such as the decoder network described with reference to FIG. 17) that accurately generate a synthetic image in response to the input prompt. For example, the synthetic image incorporates an artist associated watermark.

At operation 205, the system provides a prompt including an artist name. In some cases, the operations of this step refer to, or may be performed by, a user as described with reference to FIGS. 1 and 4.

In some cases, the user-provided prompt describes an artistic style. In some cases, the user-provided prompt describes a scene and an artistic style. For example, the user (such as the user described in FIG. 1) provides a text prompt instructing the image processing apparatus to generate a synthetic image that accurately depicts a style of the artist in the prompt. As shown in FIG. 2, the user provides a prompt comprising a natural language description of an artistic style such as “A picture in the style of VanGogh” to the image processing apparatus via a user interface of a user device (such as a user interface of user device 110 described with reference to FIG. 1).

At operation 210, the system captures the name of the artist. In some cases, the operations of this step refer to, or may be performed by, an image processing apparatus as described with reference to FIGS. 1, 3-4, and 16.

According to an embodiment of the present disclosure, the image processing apparatus obtains the user-provided prompt. In some cases, the image processing apparatus converts the prompt into a token, wherein the image processing apparatus performs a perturbation of the token corresponding to the artist. Considering the example shown in FIG. 2, the image processing apparatus perturbs the token corresponding to “VanGogh” to generate a perturbed token.

According to an embodiment, the perturbed token is generated based on combination of a concept token with a target information. In some cases, the target information includes a bit sequence that is computed based on a comparison between a synthetic image and a clean image.

In some cases, the target information refers to a concept specific bit-sequence of a pre-defined length. In some examples, the bit sequence refers to a sequence of 12 bits. For example, the bit sequence comprises values of 0 and/or 1. In some examples, a bit sequence of a clean image refers to a zero-sequence (e.g., bit sequence of a clean image is 000000000000). In some examples, a bit sequence of synthetic image (such as a watermarked image) refers to a combined sequence of zeros and ones (e.g., bit sequence of a watermarked image is 110010101111). However, embodiments are not limited thereto, and in some examples, the bit sequence refers to a sequence of 16 bits. Further details regarding the perturbation operation are provided with reference to FIGS. 4 and 10-11.

At operation 215, the system generates a watermarked image for the artist. In some cases, the operations of this step refer to, or may be performed by, an image processing apparatus as described with reference to FIGS. 1, 3-4, and 16.

In some cases, the image processing apparatus comprises an image generation model that generates the image (such as the synthetic image described with reference to FIGS. 1 and 3) based on the captured artist name (i.e., the perturbed token obtained at operation 210). In some cases, the generated image depicts a scene provided by the input prompt obtained at operation 205 while incorporating artistic style of the artist name captured at operation 210.

For example, as shown with reference to FIG. 2, the image processing apparatus generates an image that includes a watermark specific to artist, VanGogh. The generated image is provided to the user via a user interface of the user device (such as user device 110 as described in FIG. 1). Further details regarding the generation of the image are provided with reference to at least FIGS. 3-4 and 10-11.

FIG. 3 shows an example of an image generation process 300 according to aspects of the present disclosure. Image generation process 300 is an example of, or includes aspects of, the corresponding element described with reference to FIG. 4. In one aspect, image generation process 300 includes input prompt 305, image processing apparatus 310, and synthetic image 315.

According to an embodiment, user (such as user 105 described with reference to FIG. 1) provides an input prompt (such as input prompt described with reference to FIGS. 1-2). In some cases, the input prompt comprises an artist name. In some examples, input prompt 305 is a natural language prompt based on which the user wants to generate the synthetic image.

In some cases, user provides input prompt comprising an artist name to image processing apparatus 310 via a user interface of the image processing apparatus 310. For example, as shown in FIG. 3, user provides input prompt 305 comprising a description as “a picture in the style of VanGogh” with artist name “VanGogh” to image processing apparatus 310. Input prompt 305 is an example of, or includes aspects of, the corresponding element described with reference to FIGS. 4 and 11.

Image processing apparatus 310 (such as the image processing apparatus described with reference to at least FIGS. 1-2, 4, and 16) of the present disclosure receives the input prompt comprising the artist name from the user. In some cases, the image processing apparatus 310 generates synthetic image 315 based on a style of the artist mentioned in input prompt 305.

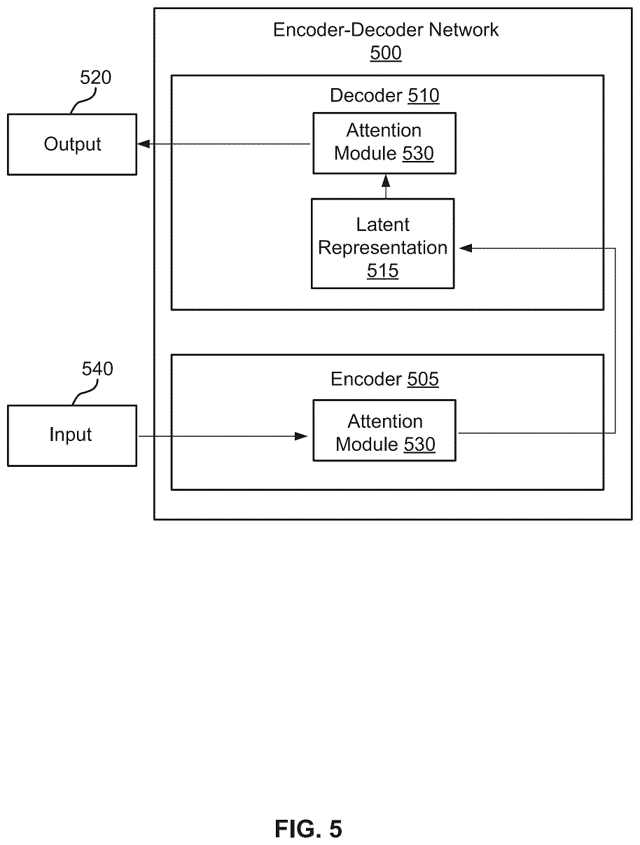

For example, the image processing apparatus comprises a concept encoder network (such as the concept encoder network 1705 described with reference to FIG. 17) that perturbs a concept token corresponding to a concept, i.e., the concept encoder network perturbs a token corresponding to the concept “VanGogh” to generate a perturbed token. In some cases, image processing apparatus 310 comprises an image generation network (such as the image generation network described with reference to FIGS. 5-9) that takes the perturbed token as input to obtain a watermarked image (i.e., synthetic image 315).

For example, the perturbed token is used as guidance by the image generation model to generate the synthetic watermarked image. Image processing apparatus 310 is an example of, or includes aspects of, the corresponding element described with reference to FIGS. 1 and 4. Synthetic image 315 is an example of, or includes aspects of, the corresponding element described with reference to FIGS. 4 and 11.

As described herein, perturbation introduces divergence of the norm and provides for controlled variability to the token space which contributes to the distinctiveness of the perturbed token. In some cases, the perturbation maintains a minimum overlap between the perturbed token and the original token direction. By maintaining the minimum overlap between the perturbed token and the original token, embodiments are able to provide effective attribution in the synthetic image.

The present disclosure describes systems and methods for enabling artist attribution in a pre-trained image generation model. Embodiments of the present disclosure are configured to embed an artist-specific watermark in the generated image. By embedding the artist-specific watermark, embodiments are able to provide for attribution to an artist in their creative work. In some cases, the image generation model provides for selective attribution without predefining each artist information before training.

An embodiment of the present disclosure includes an image processing apparatus comprising a concept encoder network, a sequence mapper network, an image generation model, and a decoder network. In some examples, the concept encoder network uses a U-Net architecture for processing 1D sequential data. For example, a fully connected layer maps a bit sequence to a feature vector which is concatenated with the token embedding. The concatenation is provided as input to the encoder-decoder framework of U-Net to generate the perturbed token embedding.

In some examples, the sequence mapper network is a feature transformation module that encodes input indices into high-dimensional representations using an embedding-based approach. For example, the sequence mapper network uses a learnable embedding layer that maps input indices (e.g., 16) to vectors in a higher-dimensional space (e.g. 64). The embeddings are initialized and scaled to maintain a unit standard deviation. During the forward pass, the sequence mapper network retrieves embeddings for each input index, weights the embeddings element-wise based on the input tensor, and sums the weighted embeddings along the input dimension. Subsequently, for example, the sequence mapper network normalizes the sum by the square root of batch size and incorporates bias by adding 1. The sequence mapper network generates a robust high-dimensional representation for each input bit sequence.

FIG. 4 shows an example of an image generation process 400 with attribution to artist according to aspects of the present disclosure. Image generation process 400 is an example of, or includes aspects of, the corresponding element described with reference to FIG. 3. In one aspect, image generation process 400 includes user 405, input prompt 410, image processing apparatus 415, and synthetic image 420.

According to an embodiment of the present disclosure, user 405 provides input prompt 410 to image processing apparatus 415 via a user interface (such as the user interface described with reference to FIGS. 1 and 14-15) of a user device. In some cases, the input prompt 410 comprises name of an artist that wants attribution for their artistic work. For example, as shown in FIG. 4, input prompt 410 includes a placeholder (such as “[Artist name]”) that can be substituted with the name of any artist that wants attribution for their artistic work.

Image processing apparatus 415 captures the name of the artist provided in input prompt 410 and provides attribution for a concept (e.g., artistic style) in the input prompt 410. In some cases, image processing apparatus 415 generates an embedding corresponding to the input prompt 410. In some cases, image processing apparatus 415 comprises a concept encoder network (such as concept encoder network described with reference to FIGS. 10-12 and 17) and an image generation model (such as image generation model described with reference to FIGS. 5-12 and 17).

In some cases, the concept encoder network perturbs the generated embedding. For example, the concept encoder perturbs the embedding associated with the concept to incorporate an attribution feature, wherein the perturbed embedding is input to the image generation model. In some examples, image generation model comprises a latent diffusion architecture. In some cases, the perturbed embedding is used by the image generation model as guidance for generation of synthetic image 420. In some examples, synthetic image 420 is an artist-specific watermarked image.

User 405 is an example of, or includes aspects of, the corresponding element described with reference to FIG. 1. Input prompt 410 is an example of, or includes aspects of, the corresponding element described with reference to FIGS. 3 and 11. Image processing apparatus 415 is an example of, or includes aspects of, the corresponding element described with reference to FIGS. 1 and 3. Synthetic image 420 is an example of, or includes aspects of, the corresponding element described with reference to FIGS. 3 and 11.

FIG. 5 shows an example of an encoder-decoder network 500 according to aspects of the present disclosure. The example shown includes encoder module 505 and decoder module 510. Additionally, the example shown includes input 540, latent space representation 515, and output 520. According to some aspects, encoder-decoder network 500 is implemented in the image generation model described with reference to FIGS. 6-9.

According to some aspects, encoder network 505 is implemented as an image encoder. According to some aspects, encoder 505 is implemented as a text encoder of conditional text encoder.

In some cases, encoder network 505 receives an input data representation (e.g., a low-resolution image, a text description, or a noise vector). Next, the encoder network 505 processes the input data representation using one or more neural network layers. The encoder network 505 extracts salient features and compresses them into a latent representation 515. For example, the encoder network 505 may employ convolutional neural networks (CNNs), recurrent neural networks (RNNs), or transformer-based architectures to encode spatial and contextual information.

Latent space representation 515 is a compact, high-dimensional feature space that serves as an intermediate processing step before image reconstruction. The extracted features associated with input 540 are transformed into a latent representation 515, which serves as a bottleneck for filtering out redundant information while preserving critical details for decoding. For example, latent space representation 515 may be processed using techniques such as variational autoencoders (VAEs) or contrastive learning for enhanced generalization and robustness.

Decoder network 510 receives latent space representation 515 and reconstructs an output image 520. For example, the decoder network 510 applies a series of deconvolutional (transposed convolution) layers, attention mechanisms, and up-sampling techniques for generation of the output image 520.

In some examples, decoder network 510 leverages generative adversarial network (GAN) structures, autoencoders, or diffusion-based models to enhance image realism. Reconstructed image 520 is refined through iterative learning and optimization, ensuring structural consistency and high perceptual quality.

In some cases, an attention module 525 is incorporated within the encoder and decoder, providing for the image generation model to dynamically focus on relevant regions of the input data. In some cases, implementation of the attention module 525 provides for enhanced image quality.

According to an exemplary embodiment, the encoder-decoder network 500 is trained using adversarial loss, perceptual loss, and reconstruction loss to ensure that the generated images are visually plausible and semantically meaningful. The loss function may be optimized using stochastic gradient descent (SGD) or Adam optimizers.

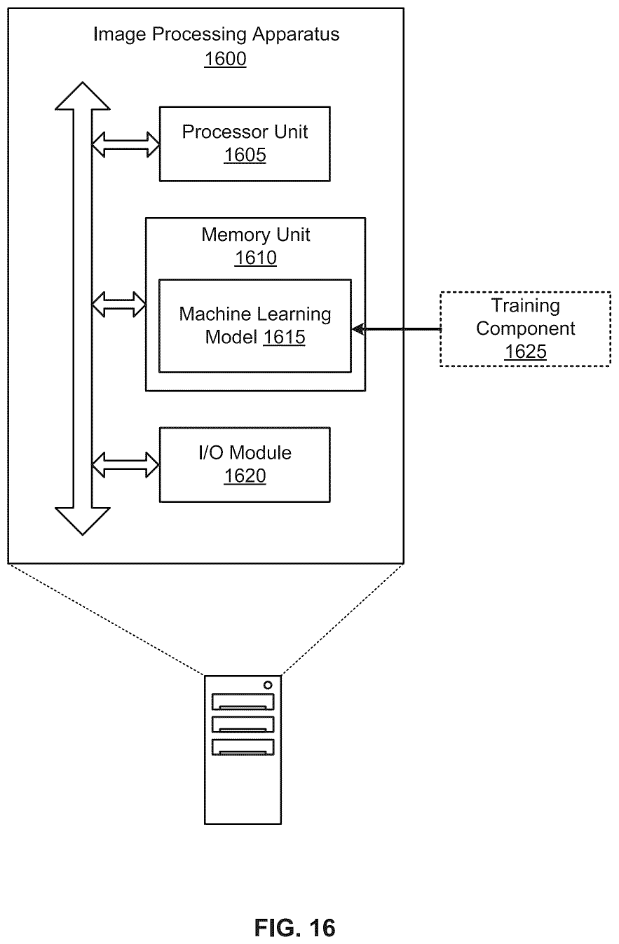

FIG. 6 shows an example of a guided diffusion model 600 according to aspects of the present disclosure. In some examples, guided diffusion model 600 describes the operation and architecture of the machine learning model 1615 described with reference to FIG. 16. The guided latent diffusion model 600 depicted in FIG. 6 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 600 may take an original media item 605 in a pixel space 610 as input and apply forward diffusion process 615 to gradually add noise to the original media item 605 to obtain noisy media item 620 at various noise levels.

Next, a reverse diffusion process 625 (e.g., a U-Net) gradually removes the noise from the noisy media item 620 at the various noise levels to obtain an output media item 630. In some cases, an output media item 630 is created from each of the various noise levels. The output media item 630 can be compared to the original media item 605 to train the reverse diffusion process 625.

The reverse diffusion process 625 can also be guided based on a text prompt 635, or another guidance prompt, such as an image, a layout, a segmentation map, etc. The text prompt 635 can be encoded using a text encoder 665 (e.g., a multimodal encoder) to obtain guidance features 645 in guidance space 650. The guidance features 645 can be combined with the noisy media item 620 at one or more layers of the reverse diffusion process 625 to ensure that the output media item 630 includes content described by the text prompt 635. For example, guidance features 645 can be combined with the noisy features using a cross-attention block within the reverse diffusion process 625.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

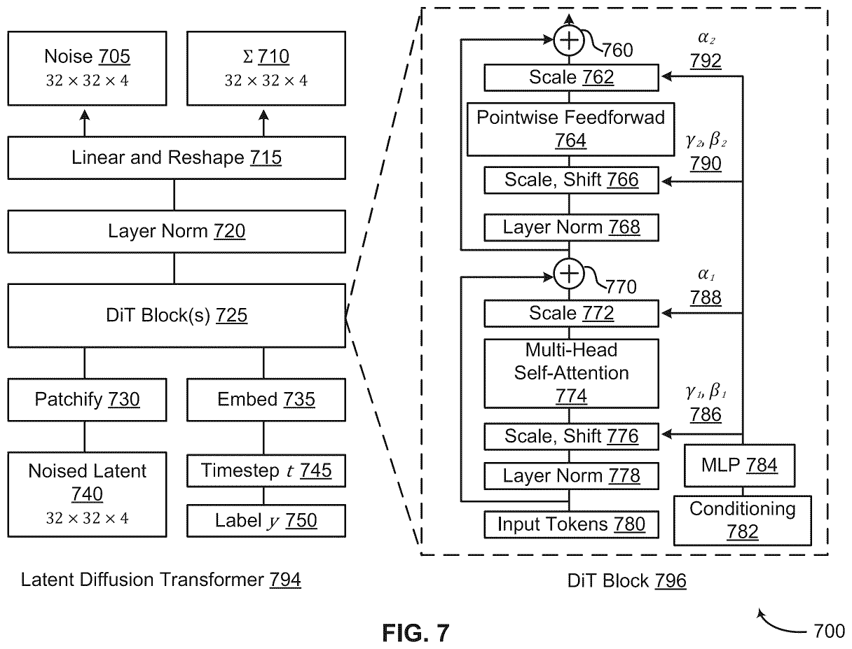

FIG. 7 shows an example of a diffusion transformer (DiT) architecture 700 according to aspects of the present disclosure. The example shown includes predicted noise 705, predicted covariance 710, linear and reshape layers 715, normalization layer 720, DiT block(s) 725, patchify operation 730, embedding 735, noised latent 740, timestep information 745, label information 750, and an implementation of one block in the DiT block(s) 725 by a DiT Block 796. The DiT Block 796 includes: second residual connection 760, second scaling operations 762, feed-forward network 764, post-normalization second scaling and shifting 766, second normalization 768, first residual connection 770, first scaling operations 772, self-attention 774, post-normalization first scaling and shifting 776, first normalization 778, input tokens 780, conditioning tokens 782, multi-layer perceptron (MLP) 784, post-normalization first scaling and shifting parameters 786, first scaling parameter 788, post-normalization second scaling and shifting parameters 790, and second scaling parameter 792. In some embodiments, the architecture employes an Latent Diffusion Transformer 794. In some embodiments, DiT Block 796 employs an “adaLN-Zero” technique.

Diffusion Transformers (DiTs) is a popular architecture for diffusion models and is designed to be structurally faithful to standard transformer architecture. DiT incorporates transformer structures' scaling properties. For training denoising diffusion probabilistic models (DDPMs) of images (e.g., spatial representations of images), DiT is based on a Vision Transformer (ViT) architecture which operates on sequences of patches. DiT processes images by dividing them into patches, converting these patches into tokens, and applying attention mechanisms to model relationships between different regions of the image. This approach allows the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where I is another shape parameter, thus halving p will quadruple T, which in some cases at least quadruples total of transformer Giga Floating Point Operations (Gflops). In some examples, changing p has no impact on downstream parameter counts, i.e., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β, in adaLN the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks, which leverages zero-initialization techniques. In Residual Networks (ResNets), initializing each residual block as the identity function x [symbol] x is beneficial. In some examples, zero-initializing a final batch norm scale factor γ in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (MLP) to output a zero-vector for all as; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small(S), Base (B), Large (L) variants, XLarge (XL) variants of model sizes are implemented. Small or Base model sizes have N=12 layers of DiT blocks, Large model sizes have 24 layers of DiT blocks. XLarge model sizes have 28 layers of DiT blocks.

After a final DiT block, the DiT network decodes the sequence of image tokens into an output noise prediction and an output diagonal covariance prediction. Both outputs have shape equal to an original spatial input. Standard linear decoder is utilized to decode, wherein a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into their original spatial layout to get the predicted noise and covariance.

The architecture 700, in some cases, employs a Latent Diffusion Transformer 794. The architecture 700 processes noised latent 740, which may be a noised version of an input image encoded in a latent space. Patchify operation 730 divides the noised latent into a sequence of patches that are processed as tokens. The tokens are vector representations of each patch of the image in latent space and are adjusted through attention processes. Each of the tokens also receives timestep information 745 and label information 750 and, accordingly, their embedding 735, which encodes the current denoising timestep and class labels as conditional information. In some cases, embedding 735 is referred to as conditional embedding or conditional information embedding. In some cases, a positional embedding which encodes each token's spatial position in the image is applied to the patchified input tokens at the patchify operations 730. In some examples the positional embedding is ViT frequency-based positional embedding. The input tokens 780 generated by the patchify operation 730 and the conditioning tokens 782 generated by the embedding 735 are processed through N DiT block(s) 725, where N may be 12, 24 or 28. Other values of N may be used. In some cases, conditional tokens refer to tokens generated based on embedding 735, encoding timestep information 745 and label information 750.

Each of the DiT block(s) 725 includes multiple processing stages. DiT Block 796 illustrates an embodiment of one block in the DiT block(s) 725. In some embodiments, the DiT Block 796 is an example of, or includes aspects of, the adaLN-Zero block. In some cases, input tokens 780 interact with the conditioning tokens 782 through multiple attention mechanisms. Particularly, after first normalization 778 applied to the input tokens and MLP 784 to the conditional tokens, MLP 784 generates or updates post-normalization first scaling and shifting parameters 786, denoted as γ₁, β₁, for post-normalization first scaling and shifting 776 to scale and shift the output of first normalization 778 accordingly. As the normalized input tokens obtained from first normalization 778 are scaled and shifted at post-normalization first scaling and shifting 776 using the conditional information carried as least in γ₁, β₁, this allows the input information and conditional information to interact. Self-attention 774 allows the scaled and shifted normalized input tokens, namely the output from post-normalization first scaling and shifting 776, to attend to each other. MLP 784 also generates or updates first scaling parameter 788 denoted as α₁ for first scaling operations 772 to scale the output of self-attention 774 (e.g., multi-head self-attention), further interacting the input information and conditional information. The input tokens 780 is then summed with the output of first scaling operations 772 at first residual connection 770. In some examples, α₁ has initial values 0, and the DiT Block 796 is initialized as the identity function.

A similar process is performed in a second half of the DiT Block 796. MLP 784 generates or updates post-normalization second scaling and shifting parameters 790, denoted as γ₂, β₂, for post-normalization second scaling and shifting 766 to scale and shift the output of second normalization 768 accordingly. As the output from second normalization 768 is scaled and shifted using the conditional information carried at least in γ₂, β₂, this allows the input information and conditional information to further interact. Feed-forward network 764 then processes the scaled and shifted output from post-normalization second scaling and shifting 766. MLP 784 also generates or updates second scaling parameter 792 denoted as α₂ for second scaling operations 762 to scale the output of feed-forward network 764, further interacting the input information and conditional information. In some cases, the feed-forward network 764 is a pointwise feed-forward network. The output from first residual connection 770 is then summed with the output of second scaling operations 762 at second residual connection 760, and the result is the final output of DiT Block 796. In some examples, α₂ has initial values 0, and the DiT Block 796 is initialized as the identity function. This process repeats for each DiT block in the sequence.

After processing through all DiT block(s) 725, the outputs undergo normalization layer 720 followed by linear and reshape layers 715. The final output is the predicted noise 705, which represents the model's prediction of the noise that was added to initially create the noised latent 740, and the predicted covariance 710, which represents the model's prediction of the covariance. The predicted noise 705 is removed from noised latent 740 at each diffusion timestep, and the predicted covariance may affect how noise is removed or resampled in the reverse or denoising process. At the end of the denoising schedule, the latent sample is decoded to generate the synthetic image in pixel space.

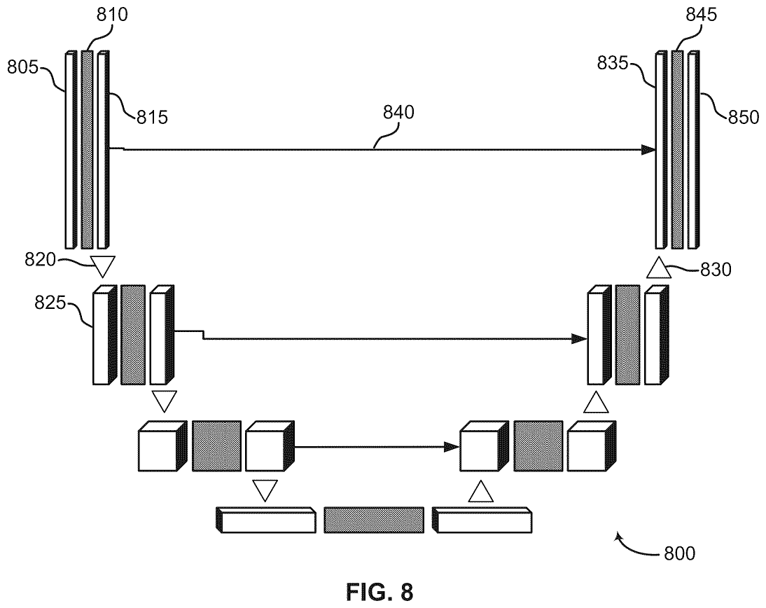

FIG. 8 shows an example of a U-Net 800 according to aspects of the present disclosure. In some examples, U-Net 800 is an example of the component that performs the reverse diffusion process 625 of guided diffusion model 600 described with reference to FIG. 6 and includes architectural elements of the machine learning model 1615 described with reference to FIG. 16. The U-Net 800 depicted in FIG. 8 is an example of, or includes aspects of, the architecture used within the reverse diffusion process described with reference to FIG. 6.

In some examples, diffusion models are based on a neural network architecture known as a U-Net. The U-Net 800 takes input features 805 having an initial resolution and an initial number of channels and processes the input features 805 using an initial neural network layer 810 (e.g., a convolutional network layer) to produce intermediate features 815. The intermediate features 815 are then down-sampled using a down-sampling layer 820 such that down-sampled features 825 features have a resolution less than the initial resolution and a number of channels greater than the initial number of channels.

This process is repeated multiple times, and then the process is reversed. That is, the down-sampled features 825 are up-sampled using up-sampling process 830 to obtain up-sampled features 835. The up-sampled features 835 can be combined with intermediate features 815 having the same resolution and number of channels via a skip connection 840. These inputs are processed using a final neural network layer 845 to produce output features 850. In some cases, the output features 850 have the same resolution as the initial resolution and the same number of channels as the initial number of channels.

In some cases, U-Net 800 takes additional input features to produce conditionally generated output. For example, the additional input features could include a vector representation of an input prompt. The additional input features can be combined with the intermediate features 815 within the neural network at one or more layers. For example, a cross-attention module can be used to combine the additional input features and the intermediate features 815.

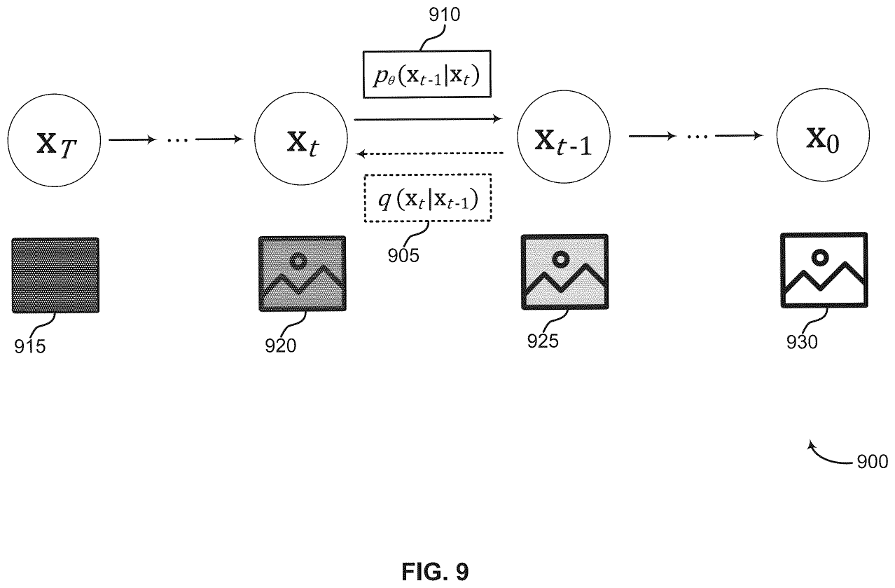

FIG. 9 shows a diffusion process 900 according to aspects of the present disclosure. In some examples, diffusion process 900 describes an operation of the machine learning model 1615 described with reference to FIG. 16, such as the reverse diffusion process 625 of guided diffusion model 600 described with reference to FIG. 6.

As described above with reference to FIG. 6, using a diffusion model can involve both a forward diffusion process 905 for adding noise to a media item (or features in a latent space) and a reverse diffusion process 910 for denoising the media item (or features) to obtain a denoised media item. The forward diffusion process 905 can be represented as q(xₜ|xₜ₋₁), and the reverse diffusion process 910 can be represented as p(xₜ₋₁|xₜ). In some cases, the forward diffusion process 905 is used during training to generate media items with successively greater noise, and a neural network is trained to perform the reverse diffusion process 910 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 910, the model begins with noisy data x_{T}, such as a noisy media item 915 and denoises the data to obtain the p(xₜ₋₁|xₜ). At each step t−1, the reverse diffusion process 910 takes xₜ, such as first intermediate media item 920, and t as input. Here, t represents a step in the sequence of transitions associated with different noise levels, The reverse diffusion process 910 outputs xₜ₋₁, such as second intermediate media item 925 iteratively until x_{T} reverts back to x₀, the original media item 930. The reverse process can be represented as:

p_{θ}(xₜ₋₁|xₜ):=N(xₜ₋₁;μ_{θ}(xₜ,t),Σ_{θ}(xₜ,t)) (1)

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(x_{T})=N(x_{T}; 0, l) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

In case of a forward pass, the image generation network retrieves an embedding associated with each input index of the plurality of input indices. Subsequently, the image generation network performs an element-wise weighting of the embeddings based on an input tensor. The weighted embeddings are combined (e.g., summed up) along the input dimension. In some examples, the combination is normalized by a square root of the batch size and a bias is incorporated by adding 1 which results in generation of a robust high-dimensional representation of each input bit sequence.

Accordingly, an apparatus for image processing is described. One or more aspects of the apparatus include a memory component; a processing device coupled to the memory component, the processing device configured to perform operations comprising:; obtaining an input prompt and a target information, wherein the input prompt indicates an image concept; generating, using a concept encoder network, a concept token based on the input prompt and the target information, wherein the concept token represents the image concept and the target information; and generating, using an image generation model, a synthetic image based on the concept token, wherein the synthetic image depicts the image concept and includes an encoding of the target information.

In some aspects, the concept encoder network comprises a U-Net architecture. In some aspects, the image generation model comprises latent diffusion model.

Some examples of the apparatus and system further include a sequence mapper network configured to generate a noise map based on the target information, wherein the synthetic image is generated based on the noise map. Some examples of the apparatus and system further include a decoder network configured to decode the synthetic image to obtain the target information.

### Image Attribution Process

The present disclosure describes systems and methods for image generation. In some cases, an input prompt and a cross-attention mechanism together guide image generation. In some examples, the image generation is performed using an image generation model comprising a text-to-image latent diffusion model. For example, the input prompt is processed by a concept encoder network, wherein the concept encoder network generates a text embedding. In some cases, the text embedding conditions the sampling process by capturing a meaning of the input prompt.

According to an embodiment of the present disclosure, the concept encoder network perturbs an input to the image generation model to add an attribution feature. In some cases, a training component fine-tunes an attention weight of the image generation model. In some cases, the concept encoder network and the sequence mapper network are used to perturb the input token embedding p_{c}_{ᵢ} and the input Gaussian noise E, respectively, based on encoding a concept-specific target information into the input.

Accordingly, the concept encoder network generates a perturbed embedding \hat{p}_{c}_{ᵢ} (i.e., image concept) and the sequence mapper network generates a perturbed Gaussian noise \hat{ϵ} which are both used as input to the image generation model (i.e., latent diffusion network) to generate a synthetic watermarked image. Subsequently, the decoder network uses the synthetic image as input to generate a bit-sequence. During training, the training component fine-tunes the attention weights of the image generation model. The image generation model is guided by constraints which provides for the synthetic image to include embedded sequences while maintaining the original style of the artist.

FIG. 10 shows an example of a method 1000 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1005, the system obtains an input prompt and a target information, where the input prompt indicates an image concept. In some cases, the operations of this step refer to, or may be performed by, an image processing apparatus as described with reference to FIGS. 1, 3, and 4.

For example, in some cases, the user interface of the image processing apparatus (such as image processing apparatus 1600 described with reference to FIG. 16) receives an input prompt from a user. In some examples, the input prompt comprises concept information (e.g., an artist name) based on which the user wants to generate a synthetic image. In some examples, the image processing apparatus receives the input prompt comprising the artist information from a database or any other data source.

In some cases, a prompt and a cross-attention mechanism together guide image generation in case of a text-to-image latent diffusion model. For example, the input prompt is processed by a text encoder, wherein the text encoder generates a text embedding (i.e., a preliminary concept token). In some cases, the text embedding conditions the sampling process by capturing a meaning of the input prompt.

Additionally, according to an embodiment, the image processing apparatus receives a target information and uses the target information to generate the concept token. In some cases, the target information refers to a concept specific bit-secret of a pre-defined length. In some examples, the bit sequence refers to a sequence of 12 bits. In some examples, the bit sequence refers to a sequence of 16 bits. For example, the bit sequence comprises values of 0 and/or 1.

At operation 1010, the system generates a concept token based on the input prompt and the target information, where the concept token represents the image concept and the target information. In some cases, the operations of this step refer to, or may be performed by, a concept encoder network as described with reference to FIG. 17.

According to an embodiment, a concept in the preliminary concept token is perturbed. In some cases, the concept encoder network ε_{c} perturbs each token of the preliminary concept token (such as a preliminary concept token described in FIG. 11) to generate a concept token. In case of the i^{th} concept, the concept token embedding p_{c}_{ᵢ} is encrypted using ε_{c} as:

p_{c}_{ᵢ}=ε_{c}(p_{c}_{ᵢ},sᵢ) (3)

where sᵢ is a concept specific bit-sequence of length l, i.e., sᵢ={bᵢ₁, bᵢ₂, . . . , bᵢ₁} where bᵢₗ∈{0,1}. In some cases, after the encryption, the original embedding is replaced by the encrypted text embedding which results in the encrypted prompt token embeddings (i.e., concept token): \hat{P}={p₁, p₂, . . . , \hat{p}_{c}, . . . , pₙ}.

At operation 1015, the system generates a synthetic image based on the concept token, where the synthetic image depicts the image concept and includes an encoding of the target information. In some cases, the operations of this step refer to, or may be performed by, an image generation model as described with reference to FIG. 17.

The image generation model comprising a latent diffusion model (such as described with reference to FIGS. 6-9) takes concept token \hat{P} as input (i.e., instead of the token embedding P) to obtain the watermarked image. In some cases, the latent diffusion model denoises the concept token \hat{P} to generate the synthetic image. For example, the synthetic image includes a concept-specific watermark (such as an artist-specific watermark). In some cases, the generated synthetic image is provided to the user via a user interface of the user device (such as user interface and user device described with reference to FIGS. 1 and 15-16).

FIG. 11 shows an example of a method 1100 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1105, the system obtains an input prompt and a target information, where the input prompt indicates an image concept. In some cases, the operations of this step refer to, or may be performed by, an image processing apparatus as described with reference to FIGS. 1, 3, and 4.

For example, in some cases, the user interface of the image processing apparatus (such as image processing apparatus 1600 described with reference to FIG. 16) receives an input prompt from a user. In some examples, the input prompt comprises concept information (e.g., an artist name) based on which the user wants to generate a synthetic image. In some examples, the image processing apparatus receives the input prompt comprising the artist information from a database or any other data source.

At operation 1110, the system generates, using a sequence mapper network, a noise map based on the target information. In some cases, the operations of this step refer to, or may be performed by, a sequence mapper network as described with reference to FIG. 17.

According to an embodiment, a concept in the preliminary concept token is perturbed. In some cases, the sequence mapper network perturbs a noise (e.g., Gaussian noise) input to the latent diffusion model based on encoding the concept-specific bit-sequence. The sequence mapper network generates the perturbed Gaussian noise \hat{ϵ} which is used as input to the image generation model (i.e., latent diffusion network) to generate the synthetic image.

In some cases, the mapper network estimates a perturbation using the i^{th} bit sequence sᵢ as: δ= [symbol] _{c}(sᵢ). The perturbation is added to the initially sampled Gaussian noise e for performing image generation. The perturbed noise is given as:

\hat{ϵ}=ϵ+α× [symbol] _{c}(sᵢ) (4)

where α controls the magnitude of δ. The image generation model (such as latent diffusion model) takes perturbed Gaussian noise \hat{ϵ} along with the encrypted prompt token embeddings (i.e., concept token) \hat{P} as input to generate the synthetic image.

At operation 1115, the system generates a synthetic image based on the concept token, where the synthetic image depicts the image concept and includes an encoding of the target information. In some cases, the operations of this step refer to, or may be performed by, an image generation model as described with reference to FIG. 17.

Accordingly, a method for image processing is described. One or more aspects of the method include obtaining an input prompt and a target information, wherein the input prompt indicates an image concept; generating, using a concept encoder network, a concept token based on the input prompt and the target information, wherein the concept token represents the image concept and the target information; and generating, using an image generation model, a synthetic image based on the concept token, wherein the synthetic image depicts the image concept and includes an encoding of the target information.

Some examples of the method, apparatus, and non-transitory computer readable medium further include generating a noise map based on the target information, wherein the synthetic image is generated based on the noise map. Some examples of the method, apparatus, and non-transitory computer readable medium further include generating the synthetic image comprises performing a diffusion process based on the concept token and the noise map.

Some examples of the method, apparatus, and non-transitory computer readable medium further include generating the concept token comprises identifying a preliminary concept token representing the image concept based on the input prompt, wherein the concept token is generated based on the preliminary concept token.

Some examples of the method, apparatus, and non-transitory computer readable medium further include decoding the synthetic image to obtain the target information. Some examples of the method, apparatus, and non-transitory computer readable medium further include determining a provenance of the synthetic image based on the target information.

In some aspects, the concept token is generated based on a regularization loss that causes a similarity between the concept token and the preliminary concept token. In some aspects, the synthetic image is generated based on a style loss that causes the synthetic image to depict the image concept. In some aspects, the synthetic image is generated based on a cross-entropy loss that causes the synthetic image to include the target information.

Additionally, a method for image processing is described. One or more aspects of the method include obtaining an input prompt and a target information, wherein the input prompt indicates an image concept; generating, using a sequence mapper network, a noise map based on the target information; and generating, using an image generation model, a synthetic image based on the input prompt and the noise map, wherein the synthetic image depicts the image concept and includes an encoding of the target information.

Some examples of the method, apparatus, and non-transitory computer readable medium further include generating a concept token based on the input prompt and the target information, wherein the concept token represents the image concept and the target information, and wherein the synthetic image is generated based on the concept token.

Some examples of the method, apparatus, and non-transitory computer readable medium further include performing a diffusion process based on the concept token and the noise map. Some examples of the method, apparatus, and non-transitory computer readable medium further include identifying a preliminary concept token representing the image concept based on the input prompt, wherein the concept token is generated based on the preliminary concept token.

Some examples of the method, apparatus, and non-transitory computer readable medium further include decoding the synthetic image to obtain the target information. Some examples of the method, apparatus, and non-transitory computer readable medium further include determining a provenance of the synthetic image based on the target information.

### Training the System

The present disclosure describes systems and methods for concept attribution in a pre-trained image generation model. Embodiments of the present disclosure are configured to embed concept-specific watermark in the generated image. By embedding the concept-specific watermark, embodiments provide for an artist to request attribution for a creative work. In some cases, the image generation model provides for selective attribution without predefining each concept before training. The image generation model performs sequential learning to add a new concept.

By performing the sequential learning, embodiments can provide attribution for an artist style while maintaining image quality. Additionally, by fine-tuning the image generation model for a new concept with minimal computational overhead, embodiments of the present disclosure streamline the attribution process while providing a scalable method for generation of a watermarked image.

In some cases, a training component of the image processing apparatus applies a regularization loss during the initial iterations of training. The regularization ensures that the perturbed tokens start with a meaningful deviation from the original tokens. By disabling the regularization loss after the initial iterations of training, embodiments are able to provide for the perturbed tokens to diverge. By maintaining the separation between the original token and the perturbed token, embodiments are able to generate a robust watermark while preserving the quality of attribution.

FIG. 12 shows an example of a method for training the image generation model 1200 according to aspects of the present disclosure. In one aspect, training process 1200 includes input prompt 1205, image concept 1210, concept token 1215, preliminary concept token 1220, target information 1225, noise map 1230, perturbed noise map 1260, perturbation 1265, and synthetic image 1235. In some examples, training process 1200 is performed using image generation model 1240, concept encoder network 1245, sequence mapper network 1250, and decoder network 1255.

The present disclosure describes systems and methods for image generation. In some cases, a prompt and a cross-attention mechanism together guide image generation in case of a text-to-image latent diffusion model. For example, the input prompt is processed by a text encoder, wherein the text encoder generates a text embedding. In some cases, the text embedding conditions the sampling process by capturing a meaning of the input prompt.

The cross-attention mechanism enables the image generation model to attend to specific parts of the text embedding that guides the diffusion process to align the output with the input prompt. The scaled dot product attention for key K, query Q, and value V is given as:

$$Attention ( Q , K , V ) = softmax ( \frac{Q {K}^{T}}{\sqrt{{d}_{k}}} ) V \qquad ( 5 )$$

Additionally, multi-head cross-attention with respective weight matrices

$${W}_{i}^{*} s ,$$

is utilized to improve generation quality by processing the prompt with multiple attention heads:

$$Multihead ( Q , K , V ) = Concat ( {H}_{1} , … {H}_{h} ) W \qquad ( 6 )$$

$${H}_{i} = Attention ( {QW}_{i}^{Q} , {KW}_{i}^{K} , {VW}_{i}^{V} ) \qquad ( 7 )$$

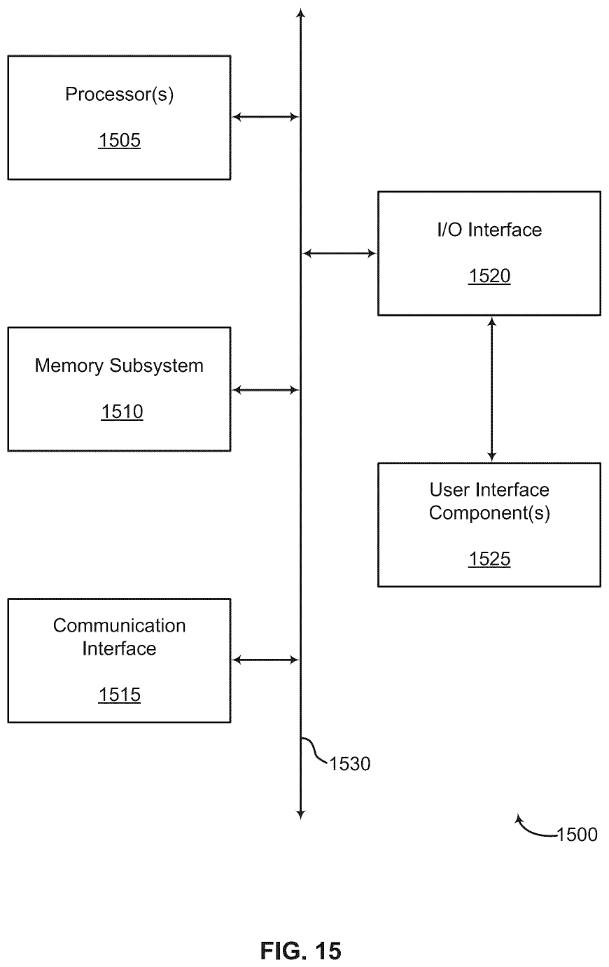

Since the multi-head cross-attention in Eq. (7) is used to establish a relationship between prompts and the generated synthetic image, the training component (such as training component described with reference to FIG. 15) fine-tunes weight matrices

$${W}_{i}^{*} s$$

which results in significantly reducing training time while enhancing critical associations between the concept 1210 and the associated watermarked image 1235.

Let [symbol] represent a set of N distinct concepts (e.g., concept 1210) with the training dataset of image generation model 1240. For instance, the image processing apparatus of the present disclosure provides attribution for M concepts (e.g., concept 1210) among the N distinct concepts, i.e., [symbol] ={c₁, c₂, . . . c_{M}}. In some cases, the corresponding embeddings (i.e., preliminary concept token 1220) are represented as P_{c}={p_{c}_{₁}, p_{c}_{₂}, . . . , p_{c}_{_{M}}}. Given a synthetic image 1235 (X) generated by image generation model 1240 using p_{c}_{ᵢ}∈P_{c}, along with other prompt token embeddings, an input prompt is given as P={p₁, p₂, . . . , p_{c}_{ᵢ}, . . . , pₙ}. The objective of concept attribution is to map X to a corresponding preliminary concept token 1220 cᵢ. In some cases, the mapping function ƒ is given as cᵢ=ƒ(X).

The image processing apparatus is configured to perturb an input to image generation model 1240 to add an attribution feature. In some cases, the training component fine-tunes an attention weight of image generation model 1240 comprising a latent diffusion model. In some cases, concept encoder network 1245 and sequence mapper network 1250 are used to perturb the input token embedding (i.e., preliminary concept token 1220) p_{c}_{ᵢ} and the input Gaussian noise 1230 ϵ, respectively, based on encoding a concept-specific target information (e.g., bit sequence) 1225 into the input.

Accordingly, concept encoder network 1245 generates a perturbed embedding 1215 \hat{p}_{c}_{ᵢ} (i.e., image concept token) that is used as input to image generation model 1240 (i.e., latent diffusion network) to generate synthetic image 1235. Additionally, sequence mapper network 1250 generates a perturbed Gaussian noise 1260 \hat{ϵ} that is used as input to image generation model 1240 (i.e., latent diffusion network) to generate synthetic image 1235. Subsequently, decoder network 1255 uses synthetic image 1235 as input to generate bit-sequence 1225. During training, the training component fine-tunes the attention weights in Eq. 6 and 7 of the latent diffusion model. The image processing apparatus of the present disclosure is guided by constraints which provides for synthetic image 1235 to include embedded sequences while maintaining the original style of the artist.

According to an embodiment, a concept 1210 in the preliminary concept token 1220 is perturbed. In some cases, concept encoder network 1245 perturbs each token of the preliminary concept token 1220 to generate a concept token embedding 1215. In case of the i^{th} concept, the concept token embedding 1215 p_{c}_{ᵢ} is encrypted using concept encoder network 1245 ε_{c} as:

p_{c}_{ᵢ}=ε_{c}(p_{c}_{ᵢ},sᵢ) (8)

where sᵢ is a concept specific bit-sequence of length l, i.e., sᵢ={bᵢ₁, bᵢ₂, . . . , bᵢₗ} where bᵢₗ∈{0,1}.

In some cases, after the encryption, the original embedding is replaced by the encrypted text embedding which results in the encrypted prompt token embeddings (i.e., concept token 1215): \hat{P}={p₁, p₂, . . . , \hat{p}_{c}, . . . , pₙ}. Accordingly, image generation model 1240 (i.e., latent diffusion model) takes concept token 1215 \hat{P} as input (i.e., instead of the preliminary token embedding 1220 P) to obtain the watermarked image 1235. In some cases, a regularization mean squared error (MSE) loss is computed between preliminary concept token 1220 P and concept token 1215 \hat{P} at initial iterations, which enables the concept encoder network 1245 to preserve the style and support sequence learning. The regularization loss is given as:

$${J}_{R e g} = {‖ \hat{P} - P ‖}_{2}^{2} \qquad ( 9 )$$

An embodiment of the present disclosure includes a mapper network for performing the sequence learning process. For example, sequence mapper network 1250 and concept encoder network 1245 are used to accelerate the process of sequence learning. In some cases, sequence mapper network 1250 estimates a perturbation 1265 using the i^{th} target information (e.g., bit sequence) sᵢ as: δ= [symbol] _{c}(sᵢ). The perturbation 1265 is added to the initially sampled Gaussian noise 1230 ϵ for performing image generation. The perturbed noise 1260 is given as:

\hat{ϵ}=ϵ+α× [symbol] _{c}(sᵢ) (10)

where α controls the magnitude of δ.

Image generation model 1240 takes perturbed Gaussian noise 1260 \hat{ϵ} along with the encrypted prompt token embeddings (i.e., concept token 1215) \hat{P} as input to generate the synthetic image 1235. In some cases, a training process of the image generation model 1240 is based on fine-tuning the attention layers of the latent diffusion model (such as latent diffusion network described with reference to FIG. 6) while fixing the other layers.

An embodiment of the present disclosure generates clean and watermarked images during a training process. During the training process, image generation model 1240 generates clean image 1270 X and a watermarked image 1235 \hat{X} using input (P, ϵ) and (P, \hat{ϵ}), respectively. A pre-trained style model (e.g., a pre-trained contrastive style descriptor (CSD) model) extracts style descriptor d and \hat{d} from the clean image 1270 X and the watermarked image 1235 \hat{X}, respectively. For example, the style model contains concise and effective style information. Additionally, in some cases, the style model is invariant to semantic content and can disentangle multiple styles.

An embodiment of the present disclosure is configured to maximize cosine similarity between the two style descriptors. By maximizing the cosine similarity between the descriptors, embodiments of the present disclosure are able to match a style of the original image with the watermarked image. Moreover, a mean square error loss (in addition to the style descriptor (CSD) loss) is applied between the clean image 1270 X and the watermarked image 1235 \hat{X} to support style matching. The style loss is given as:

$${J}_{Sty} = 1 - cos ( \hat{d} , d ) + {‖ X - \hat{X} ‖}_{2}^{2} \qquad ( 11 )$$

Further, decoder network 1255 takes watermarked image 1235 \hat{X} and clean image 1270 X as input and estimates a bit sequence (i.e., target information) 1225 in the watermarked image \hat{X} and clean image X. For example, decoder network 1255 outputs a zeros sequence for clean image 1270 X and sequence sᵢ for watermarked image 1235 \hat{X}. Decoder network 1255 is trained using a binary cross-entropy loss between a ground-truth bit sequence sᵢ and the predicted bit sequence (i.e., target information) ŝᵢ. The binary cross-entropy loss is given as:

$${J}_{B C E} ( {s}_{i} , {\hat{s}}_{i} ) = - \frac{1}{l} {\sum }_{j = 1}^{l} [ {b}_{j} log {\hat{b}}_{j} + ( 1 - {b}_{j} ) log ( 1 - {\hat{b}}_{j} ) ] \qquad ( 12 )$$

where, bⱼ corresponds to a true label, \hat{b}ⱼ corresponds to a predicted probability, and l refers to the number of samples.

The image processing apparatus of the present disclosure is trained in an end-to-end manner. By performing end-to-end training, embodiments of the present disclosure are able to minimize an objective function during training. In some cases, the objective function is given as [symbol] ₐₜₜᵣ= [symbol] _{Sty}+ [symbol] _{BCE}+β [symbol] _{Reg} during training, e.g., β=10.

In some cases, during inference time, image generation model 1240 embeds a watermark within the generated image 1235 when the Gaussian noise and the input prompt are perturbed (i.e., perturbed noise 1260 and perturbed concept token embedding 1215 provided to image generation model 1240). In some cases, decoder network 1255 decodes the watermark in the generated image 1235 to the concept specific bit-sequence. For example, the concept specific bit-sequence functions as a hidden signature for attribution.

The decoder network of the present disclosure extracts a bit sequence (i.e., target information) embedded by the image generation model to attribute the generated synthetic image 1235. The attribution mapping function ƒ is defined using the predicted bit sequence (i.e., target information) ŝᵢ= [symbol] _{c}(\hat{X}) and the bit sequence (i.e., target information) sᵢ corresponding to the concept 1210 cᵢ as:

$$f ( \hat{X} ) = {arg max}_{i ∈ [ 1 , M ]} g ( {𝒟}_{C} ( \hat{X} ) , {s}_{i} ) \qquad ( 13 )$$

$$where ,$$

$$g ( {𝒟}_{C} ( \hat{X} ) , {s}_{i} ) = g ( \hat{s} , {s}_{i} ) = {\sum }_{k = 1}^{l} [ {\hat{b}}_{k} = {b}_{ik} ] \qquad ( 14 )$$

and [\hat{b}ₖ=bⱼₖ] is an indicator function that returns 1 if the bits match, and 0 otherwise. By using the predicted bit sequence, embodiments of the present disclosure are able to assign the synthetic image to the concept with maximum match with the bit sequence, i.e., the i^{th} concept that maximizes g(ŝ, sᵢ).

An exemplary embodiment of the present disclosure is configured to perform a sequential leaning operation. In some cases, the number of concepts for attribution may not be fixed, i.e., the set of concepts can change. The image generation model of the present disclosure is initially trained on M concepts and can be fine-tuned on a new concept c_{M+1}. For instance, the training component is used to train the image generation model on M concepts, i.e., Ĉ={c₁, c₂, . . . , c_{M}} and fine-tune on the expanded set Ĉ∪c_{M+1}, such that the image generation model is pretrained on C. By fine-tuning the image generation model only on a new concept, embodiments are able to adapt to new concepts without using a predefined set during initial training.

An exemplary embodiment of the present disclosure is configured to perform multi-concept learning. In some cases, a prompt (i.e., a single prompt) comprises multiple concepts, such as “a painting of a dog in the style of Van Gogh”. In some cases, the image processing apparatus extends an attribution mechanism to process multiple concepts simultaneously which enables concept attribution.

Given two concepts, cᵢ and cⱼ, from the attributed set Ĉ, concept encoder network 1245 perturbs the respective token embeddings p_{c}_{ᵢ} and p_{c}_{ⱼ}. The perturbed embedding is given as:

\hat{p}_{c}_{ᵢ}=ε_{c}(p_{c}_{ᵢ},sᵢ)

\hat{p}_{c}_{ⱼ}=ε_{c}(p_{c}_{ⱼ},sⱼ) (15)

The perturbed prompt embeddings \hat{P}={p₁, . . . , \hat{p}_{c}_{ᵢ}, . . . , \hat{p}_{c}_{ⱼ}, . . . , pₙ} are used in the latent diffusion network (such as the image generation model 1240, further described with reference to FIGS. 5-9) to generate watermarked image \hat{X} 1235. Decoder network 1255 recovers the concatenated sequence associated with each concept during decoding:

ŝ= [symbol] _{c}(\hat{X})=[sᵢ;sⱼ] (16)

The concatenation ensures that each of the concept-specific sequence is extracted from synthetic image 1235 which enables attribution for multiple concepts simultaneously. The attribution function f is applied independently for each concept:

$$f ( \hat{X} ) = {arg max}_{i , j ∈ [ 1 , M ]} g ( {𝒟}_{C} ( \hat{X} ) , [ {s}_{i} ; {s}_{j} ] ) \qquad ( 17 )$$

By attributing each concept in a multi-concept image, embodiments of the present disclosure are able to provide for effective auditing of the generation model even when multiple stylistic and/or semantic elements are included in the generated content.

Input prompt 1205 is an example of, or includes aspects of, the corresponding element described with reference to FIGS. 3 and 4. Image concept 1210 is an example of, or includes aspects of, the corresponding element described with reference to FIGS. 4 and 10. Concept token 1215, preliminary concept token 1220, target information 1225 are examples of, or include aspects of, the corresponding element described with reference to FIGS. 4 and 10. Synthetic image 1235 is an example of, or includes aspects of, the corresponding element described with reference to FIGS. 3 and 4.

Image generation model 1240 is an example of, or includes aspects of, the corresponding element described with reference to FIGS. 4-9 and 17. Concept encoder network 1245 is an example of, or includes aspects of, the corresponding element described with reference to FIGS. 4, 8, and 17. Sequence mapper network 1250 is an example of, or includes aspects of, the corresponding element described with reference to FIGS. 4, 11, and 17. Decoder network 1255 is an example of, or includes aspects of, the corresponding element described with reference to FIGS. 4, 10, and 17.

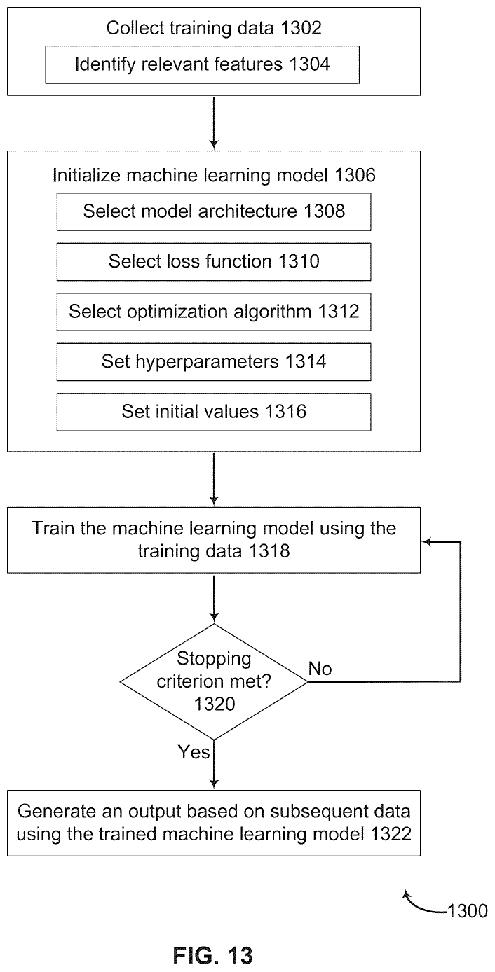

FIG. 13 shows an example of a method of training a machine learning model according to aspects of the present disclosure. FIG. 13 is a flow diagram depicting an algorithm as a step-by-step procedure 1300 in an example implementation of operations performable for training a machine-learning model. In some embodiments, the procedure 1300 describes an operation of the training component 1625 described for configuring the machine learning model 1615 as described with reference to FIG. 16. The procedure 1300 provides one or more examples of generating training data, use of the training data to train a machine-learning model, and use of the trained machine-learning model to perform a task.

To begin in this example, a machine-learning system collects training data (block 1302) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1304) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1306). Initialization of the machine-learning model includes selecting a model architecture (block 1308) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1310). The loss function is utilized to measure a difference between an output of the machine-learning model (i.e., predictions) and target values (e.g., as expressed by the training data) to be used to train the machine-learning model. Additionally, an optimization algorithm is selected (1312) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1314) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1318) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1320), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1320), the procedure 1300 continues training of the machine-learning model using the training data (block 1318) in this example.

If the stopping criterion is met (“yes” from decision block 1320), the trained machine-learning model is then utilized to generate an output based on subsequent data (block 1322). The trained machine-learning model, for instance, is trained to perform a task as described above and therefore, once trained is configured to perform that task based on subsequent data received as an input and processed by the machine-learning model. The machine learning model is an example of, or includes aspects of, the image generation model described with reference to FIGS. 2, 5-9, 13, and 14.

FIG. 14 shows an example of a method of training a diffusion model 1400 according to aspects of the present disclosure. In some embodiments, the method 1400 describes an operation of the training component 1625 described for configuring the machine learning model 1615 as described with reference to FIG. 16. The method 1400 represents an example for training a reverse diffusion process as described above with reference to FIGS. 6-9. In some examples, these operations are performed by a system including a processor executing a set of codes to control functional elements of an apparatus, such as the guided diffusion model described in FIG. 6.

Additionally or alternatively, certain processes of method 1400 may be performed using special-purpose hardware. Generally, these operations are performed according to the methods and processes described in accordance with aspects of the present disclosure. In some cases, the operations described herein are composed of various substeps or are performed in conjunction with other operations.

Referring to FIG. 14, according to some aspects, a training component (such as the training component 1625 described with reference to FIG. 16) trains a diffusion model (such as the image generation model described with reference to FIGS. 6-9) to generate an output.

At operation 1405, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1410, the system at each stage n, starting with stage N, a reverse diffusion process is used to predict the output or features at stage n−1. For example, the reverse diffusion process can predict the noise that was added by a forward diffusion process, and the predicted noise can be removed from the noise input to obtain the predicted output. In some cases, an original media item is predicted at each stage of the training process. For example, the system utilizes the reverse diffusion process to generate the media item. In some examples, the system trains the attention weight of the diffusion model.

At operation 1415, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1420, the system updates parameters of the model based on the comparison. For example, parameters of a U-Net may be updated using gradient descent. Time-dependent parameters of the Gaussian transitions can also be learned.

### Experimentation and Implementation

An exemplary embodiment of the present disclosure uses a predefined set of prompts for a concept. For instance, the image generation model of the image processing apparatus may be a Stable Diffusion 1.5 model. In some examples, the image processing apparatus is evaluated using four metrics, i.e., bit accuracy, attribution accuracy, CSD score, and CLIP score. In case of attribution assessment, bit accuracy refers to the maximum percentage of bits matched between the predicted bit-sequence and a concept-specific sequence. As described herein, attribution accuracy refers to the percentage of times the predicted bit-sequence matches with the correct concept-specific sequence. As used herein, the CSD (i.e., style) score refers to a cosine similarity between the style descriptor which assesses the style match between two images. In some cases, CLIP score refers to the cosine similarity between the CLIP image embeddings.

An exemplary embodiment of the present disclosure is configured to perform sequential learning. For example, the image generation model starts attribution with three concepts and subsequently integrates an additional concept one at a time. By performing sequential learning, embodiments of the present disclosure enable dynamic updates to concept attribution as a new style is added. Additionally, by performing sequential learning, embodiments are able to incrementally learn attributions for a new concept without erasing a previously learned style.

In some cases, the image processing apparatus is configured to utilize a prior textual inversion-based method to derive token embeddings for an unseen concept. Subsequently, the image processing apparatus applies watermark perturbations to the embedding which enables attribution for a new concept, i.e., without retraining or adjustment of the image generation model.

According to an embodiment of the present disclosure, the image processing apparatus generates a clean image. For example, the clean image refers to a non-watermarked image. In some cases, the image processing apparatus uses a text token (i.e., a non-perturbed original text token) to generate the clean image. In some examples, the sequence mapper network uses an all-zero bit sequence (i.e., target information) as input. Additionally, the decoder network generates an all-zero bit sequence (i.e., target information) as output.

### Computing Device

FIG. 15 shows an example of a computing device according to aspects of the present disclosure. The computing device 1500 may be an example of the image processing apparatus 1600 described with reference to FIG. 16. In one aspect, computing device 1500 includes processor(s) 1505, memory subsystem 1510, communication interface 1515, I/O interface 1520, user interface component(s) 1525, and channel 1530.

In some embodiments, computing device 1500 is an example of, or includes aspects of, the machine learning model of FIG. 16. In some embodiments, computing device 1500 includes one or more processors 1505 that can execute instructions stored in memory subsystem 1510 to perform media generation.

According to some aspects, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote-control device interfaced with a user interface directly or through the I/O controller), or a combination thereof. In some cases, user interface component(s) 1525 include a GUI.

FIG. 16 shows an example of an image processing apparatus 1600 according to aspects of the present disclosure. Image processing apparatus 1600 is an example of, or includes aspects of, the corresponding element described with reference to FIGS. 1-5. In one aspect, image processing apparatus 1600 includes processor unit 1605, memory unit 1610, I/O module 1620, and training component 1625. Training component 1625 updates parameters of the machine learning model 1615 stored in memory unit 1610. In some examples, the training component 1625 is located outside the image processing apparatus 1600.

According to some aspects, image processing apparatus 1600 obtains an input prompt and a target information, where the input prompt indicates an image concept.

According to some aspects, processor unit 1605 comprises a processing device coupled to the memory component. Processor unit 1605 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1605 is configured to operate a memory array using a memory controller. In other cases, a memory controller is integrated into processor unit 1605. In some cases, processor unit 1605 is configured to execute computer-readable instructions stored in memory unit 1610 to perform various functions. In some aspects, processor unit 1605 includes special purpose components for modem processing, baseband processing, digital signal processing, or transmission processing. According to some aspects, processor unit 1605 comprises one or more processors described with reference to FIG. 15.

Memory unit 1610 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1605 to perform various functions described herein.

In some cases, memory unit 1610 includes a basic input/output system (BIOS) that controls basic hardware or software operations, such as an interaction with peripheral components or devices. In some cases, memory unit 1610 includes a memory controller that operates memory cells of memory unit 1610. For example, the memory controller may include a row decoder, column decoder, or both. In some cases, memory cells within memory unit 1610 store information in the form of a logical state. According to some aspects, memory unit 1610 is an example of the memory subsystem 1510 described with reference to FIG. 15.

According to some aspects, image processing apparatus 1600 uses one or more processors of processor unit 1605 to execute instructions stored in memory unit 1610 to perform functions described herein. For example, the image processing apparatus 1600 may obtain an input prompt and a target information, wherein the input prompt indicates an image concept; generate, using a concept encoder network, a concept token based on the input prompt and the target information, wherein the concept token represents the image concept and the target information; and generate, using an image generation model, a synthetic image based on the concept token, wherein the synthetic image depicts the image concept and includes an encoding of the target information.

In one aspect, memory unit 1610 includes machine learning model 1615 trained to obtain an input prompt and a target information, wherein the input prompt indicates an image concept; generate, using a concept encoder network, a concept token based on the input prompt and the target information, wherein the concept token represents the image concept and the target information; and generate, using an image generation model, a synthetic image based on the concept token, wherein the synthetic image depicts the image concept and includes an encoding of the target information.

For example, after training, the machine learning model 1615 may perform inferencing operations as described with reference to FIGS. 1-3 to obtain an input prompt and a target information, wherein the input prompt indicates an image concept; generate, using a concept encoder network, a concept token based on the input prompt and the target information, wherein the concept token represents the image concept and the target information; and generate, using an image generation model, a synthetic image based on the concept token, wherein the synthetic image depicts the image concept and includes an encoding of the target information.

In some embodiments, the machine learning model 1615 is an Artificial neural network (ANN) comprising a plurality of networks including the guided diffusion model described with reference to FIG. 6, the diffusion transformer architecture described with reference to FIG. 7, and the U-Net described with reference to FIG. 8. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 1615 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

I/O module 1620 receives inputs from and transmits outputs of the image processing apparatus 1600 to other devices or users. For example, I/O module 1620 receives inputs for the machine learning model 1615 and transmits outputs of the machine learning model 1615. According to some aspects, I/O module 1620 is an example of the I/O interface 1520 described with reference to FIG. 15.

Training component 1625 may train the machine learning model 1615. For example, parameters of the machine learning model 1615 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 13). The goal of the training process may be to find optimal values for the parameters that allow the image generation model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 1615 can be used to make predictions on new, unseen data (i.e., during inference). Machine learning model 1615 is an example of, or includes aspects of, the corresponding element described with reference to FIG. 17.

FIG. 17 shows an example of a machine learning model 1700 according to aspects of the present disclosure. Machine learning model 1700 is an example of, or includes aspects of, the corresponding element described with reference to FIG. 16. In one aspect, machine learning model 1700 includes concept encoder network 1705, image generation model 1710, sequence mapper network 1715, and decoder network 1720.

According to some aspects, concept encoder network 1705 generates a concept token based on the input prompt and the target information, where the concept token represents the image concept and the target information. In some examples, concept encoder network 1705 generates the concept token including: identifying a preliminary concept token representing the image concept based on the input prompt, where the concept token is generated based on the preliminary concept token. In some aspects, the concept token is generated based on a regularization loss that causes a similarity between the concept token and the preliminary concept token.

According to some aspects, concept encoder network 1705 generates a concept token based on the input prompt and the target information, where the concept token represents the image concept and the target information, and where the synthetic image is generated based on the concept token. In some examples, concept encoder network 1705 identifies a preliminary concept token representing the image concept based on the input prompt, where the concept token is generated based on the preliminary concept token.

According to some aspects, concept encoder network 1705 generates a concept token based on the input prompt and the target information, wherein the concept token represents the image concept and the target information. In some aspects, the concept encoder network 1705 includes a U-Net architecture.

According to some aspects, image generation model 1710 generates a synthetic image based on the concept token, where the synthetic image depicts the image concept and includes an encoding of the target information. In some examples, image generation model 1710 generates a noise map based on the target information, where the synthetic image is generated based on the noise map. In some examples, image generation model 1710 generates the synthetic image including performing a diffusion process based on the concept token and the noise map. In some aspects, the synthetic image is generated based on a style loss that causes the synthetic image to depict the image concept. In some aspects, the synthetic image is generated based on a cross-entropy loss that causes the synthetic image to include the target information. In some examples, image generation model 1710 determines a provenance of the synthetic image based on the target information.

According to some aspects, image generation model 1710 generates a synthetic image based on the input prompt and the noise map, where the synthetic image depicts the image concept and includes an encoding of the target information. In some examples, image generation model 1710 performs a diffusion process based on the concept token and the noise map. In some examples, image generation model 1710 determines a provenance of the synthetic image based on the target information.

According to some aspects, image generation model 1710 generates a synthetic image based on the concept token, wherein the synthetic image depicts the image concept and includes an encoding of the target information. In some aspects, the image generation model 1710 includes latent diffusion model.

According to some aspects, sequence mapper network 1715 generates a noise map based on the target information. According to some aspects, sequence mapper network 1715 is configured to generate a noise map based on the target information, wherein the synthetic image is generated based on the noise map. According to some aspects, decoder network 1720 decodes the synthetic image to obtain the target information.

As used herein, an “embedding” (such as a feature representation, a contextualized visual representation, a summary visual representation, a preliminary visual representation, a text feature, or a text-conditioned visual feature) refers to a representation of an object (e.g., a frame of a video, or a sentence of a transcript) in a lower-dimensional space such that semantic information about the object is more easily captured and analyzed by a machine learning model. An example embedding is a numerical representation of the object in a continuous vector space in which objects that include similar semantic information to each other correspond to vectors that are numerically similar to and thus “closer” to each other, thereby allowing a similarity between different objects corresponding to different embeddings to be readily determined.

As used herein, a “token” refers to a portion of a text string. A token may include an entire word or a portion of a word. An image generation model refers to a machine learning model that is trained to generate an image output based on an input, such as a diffusion model. In some cases, “attention” refers to a mechanism that allows a machine learning model to focus on different parts of a sequence of tokens when making predictions. The machine learning model uses attention to weigh an importance of different tokens regardless of their position in the sequence.

An “attention pattern” refers to a distribution of per-token attention values of a machine learning model (or a portion of a machine learning model, such as an attention head or an attention layer) over a span of tokens. An “attention value” refers to a numerical measure of an amount of attention paid by a machine learning model, or a portion of the machine learning model, to a particular token.

An “attention head” refers to one of multiple parallel attention mechanisms that operate independently within a machine learning model. Each attention head processes an input sequence separately, computing attention scores and focusing on different parts of the input sequence. Using multiple attention heads allows the machine learning model to capture various relationships or aspects of the data simultaneously.

An “attention layer” comprises one or more attention heads that operate in parallel. The outputs of the attention heads are concatenated together and then passed through a linear transformation, forming the final output of the attention layer. For example, in a transformer model, multiple attention layers are stacked on top of each other, and each layer contains its own set of attention heads. Thus, an attention head is a building block within an attention layer, and the attention layer represents the combined output of one or more attention heads, contributing to the overall understanding and processing of the input sequence by the transformer.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for image processing, comprising:
obtaining an input prompt and a target information, wherein the input prompt indicates an image concept;
generating, using a concept encoder network, a concept token based on the input prompt and the target information, wherein the concept token represents the image concept and the target information; and
generating, using an image generation model, a synthetic image based on the concept token, wherein the synthetic image depicts the image concept and includes an encoding of the target information.

2. The method of claim 1, further comprising:
generating a noise map based on the target information, wherein the synthetic image is generated based on the noise map.

3. The method of claim 2, wherein generating the synthetic image comprises:
performing a diffusion process based on the concept token and the noise map.

4. The method of claim 1, wherein generating the concept token comprises:
identifying a preliminary concept token representing the image concept based on the input prompt, wherein the concept token is generated based on the preliminary concept token.

5. The method of claim 1, wherein generating the concept token comprises:
identifying a first preliminary concept token and a second preliminary concept token representing a first image concept and a second image concept, respectively, based on the input prompt, wherein the concept token is generated based on the first preliminary concept token and the second preliminary concept token.

6. The method of claim 4, wherein:
the concept token is generated based on a regularization loss that causes a similarity between the concept token and the preliminary concept token.

7. The method of claim 1, further comprising:
decoding the synthetic image to obtain the target information.

8. The method of claim 1, wherein:
the synthetic image is generated based on a style loss that causes the synthetic image to depict the image concept.

9. The method of claim 1, wherein:
the synthetic image is generated based on a cross-entropy loss that causes the synthetic image to include the target information.

10. The method of claim 1, further comprising:
determining a provenance of the synthetic image based on the target information.

11. A non-transitory computer readable medium storing code for image processing, the code comprising instructions that, when executed by at least one processor, causes the at least one processor to perform operations comprising:
obtaining an input prompt and a target information, wherein the input prompt indicates an image concept;
generating, using a sequence mapper network, a noise map based on the target information; and
generating, using an image generation model, a synthetic image based on the input prompt and the noise map, wherein the synthetic image depicts the image concept and includes an encoding of the target information.

12. The non-transitory computer readable medium of claim 11, the code further comprising instructions that, when executed by the at least one processor, causes the at least one processor to perform operations comprising:
generating a concept token based on the input prompt and the target information, wherein the concept token represents the image concept and the target information, and wherein the synthetic image is generated based on the concept token.

13. The non-transitory computer readable medium of claim 12, the code further comprising instructions that, when executed by the at least one processor, causes the at least one processor to perform operations comprising:
performing a diffusion process based on the concept token and the noise map.

14. The non-transitory computer readable medium of claim 12, wherein generating the concept token comprises:
identifying a preliminary concept token representing the image concept based on the input prompt, wherein the concept token is generated based on the preliminary concept token.

15. The non-transitory computer readable medium of claim 11, the code further comprising instructions that, when executed by the at least one processor, causes the at least one processor to perform operations comprising:
decoding the synthetic image to obtain the target information.

16. A system comprising:
a memory component; and
a processing device coupled to the memory component, the processing device configured to perform operations comprising:
obtaining an input prompt and a target information, wherein the input prompt indicates an image concept;
generating, using a concept encoder network, a concept token based on the input prompt and the target information, wherein the concept token represents the image concept and the target information; and
generating, using an image generation model, a synthetic image based on the concept token, wherein the synthetic image depicts the image concept and includes an encoding of the target information.

17. The system of claim 16, wherein:
the concept encoder network comprises a U-Net architecture.

18. The system of claim 16, wherein:
the image generation model comprises latent diffusion model.

19. The system of claim 16, further comprising:
a sequence mapper network configured to generate a noise map based on the target information, wherein the synthetic image is generated based on the noise map.

20. The system of claim 16, further comprising:
a decoder network configured to decode the synthetic image to obtain the target information.
